(19) United States
(12) Patent Application Publication
(10) Pub. No.: US 2006/0008130 A1
(43) Pub. Date: Jan. 12, 2006

(54) Medical image output system, apparatus and method

(76) Inventors: Youji Yamamichi, Tokyo (JP); Mamoru Umeki, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/158,695

(22) Filed: Jun. 21, 2005

(30) Foreign Application Priority Data
Jun. 29, 2004 (JP) JP2004-191079
Jun. 29, 2004 (JP) JP2004-191175
Jun. 29, 2004 (JP) JP2004-191184

(51) Int. Cl. G06K 9/00

(52) U.S. Cl. 382/128

(57) ABSTRACT

In controller 20, upon receipt of the instruction information of the medical image film output from image diagnosis terminal 30, information on the output form of medical image output apparatus 50a or 50b defined as an output destination is read out from an output form table, while information on the output form set as the standard output form is read out from a standard form table. Then based on the information, presence or absence of the reversing process of the medical image and the output order are set so that the film output form is a standard form. Then the information on this setting as the output instruction information and the medical image to be outputted are sent to medical image output apparatus 50a or 50b. The reversing process of the medical image is performed according to the information and the reversed image is outputted in the specified order.

This application is based on Japanese Patent Application Nos. 2004-191079, 2004-191175 and 2004-191184 filed on Jun. 29, 2004 in Japanese Patent Office, the entire content of which is hereby incorporated by reference.

### BACKGROUND OF THE INVENTION

The present invention relates to a medical image output system and a medical image output method for forming and outputting a medical image on a film sheet.

In the field of medical care, an medical image obtained by imaging for examination is outputted onto a film sheet by means of a medical image output apparatus and this film sheet is checked by a doctor specialized in diagnosis of medical images, whereby diagnosis is performed. To improve efficiency of the film output work, a method has been disclosed in prior art to output film sheets after rearranging the output order of medical images to ensure that images can be continuously outputted for each patient, when outputting medical images for a plurality of patients (e.g. Patent Document 1). An emulsion containing a photosensitive agent is applied on the substrate of the film sheet, and a photosensitive layer is formed on the film sheet. Depending on the material quality, gloss may occur on the surface of the substrate or on the surface of the photosensitive layer. Accordingly, to ensure that the surface of the film sheet selected in conformity to the preference of an image diagnosing doctor can be used for image diagnosis, the medical image is reversed and the film sheet is outputted. Such a method has also been disclosed (e.g. Patent Document 2).

The medical image output apparatus is available in two types: In one type (hereinafter referred to as “side face type”), a tray for ejecting the film sheet with an medical image formed thereon is provided on the side of the apparatus body. In the other type (hereinafter referred to as “upper portion type”), this tray is provided on the upper portion of the apparatus body.

In either type, the film sheet, the substrate of which is coated with an emulsion, containing a photosensitive agent is exposed to light from the side of the surface coated with the emulsion. This ensures that the surface coated with an emulsion is always the surface where an image is formed. Thus, in the case of the side face type apparatus shown in FIG. 15 (a), film sheet is ejected onto the tray so that the surface where an image is formed is located at a lower position. When a group of film sheets stored on the tray are viewed by an operator from the direction “A” above the film sheet, the substrate surface of the film sheet is located on the operator side. Accordingly, the medical image on the film sheet presents a mirror image as shown in FIG. 15 (b), wherein the image is reversed left to right.

Medical images are outputted onto a film sheet in the order in which data is inputted. Accordingly, if medical images are inputted in the order in which they are subjected to image diagnosis, the first image subjected to image diagnosis is first to be outputted to the film sheet. Then subsequent images subjected to image diagnosis thereafter are outputted and the film sheets are accumulated on this first image. Accordingly, the order of medical images arranged on each film sheet is opposite to the order of those subjected to image diagnosis. Actually, when the film sheets are placed in a light box for image diagnosis, medical images are correct images as shown in FIG. 15 (c) and the images are arranged for image diagnosis from left to right. Therefore, as the output form of the film sheets, if the medical images formed on the film sheet are correct images, and the order in which the medical images on each film sheet are arranged is the same as that for image diagnosis, the film arrangement work is facilitated. Thus, after a group of outputted film sheets have been removed from the tray, they must be reversed all together (the obverse and reverse sides are changed).

In the case of the upper portion type apparatus shown in FIG. 16 (a), film sheets are ejected onto the tray, while the surface where the image is formed, faces upward. When a group of film sheets accumulated on the tray are observed by the operator from direction “A”, the surface of the film sheet with images formed thereon is located on the operator side. Accordingly, the medical image on the film sheet is a correct image, as shown in FIG. 16 (b). Similarly to the case of the side face type apparatus, medical images are outputted in the order in which the data has been inputted. If the medical images are inputted in the order in which they are subjected to image diagnosis, the order in which medical images are arranged on each film sheet will be opposite to that in which they are subjected to image diagnosis. As described above, when the medical images on the film sheet are arranged in a light box, for image diagnosis, it is preferable that the medical images formed on the film sheet are correct images, as shown in FIG. 16 (c), and that the arrangement order of medical images on each film sheet is the same as that for image diagnosis. For this purpose, after the outputted group of film sheets is removed from the tray, the order of the film sheets is changed or once the group of film sheets are reversed all together and each film sheet is separated and reversed from the top of the film sheet group one by one while the film sheets are arranged in the light box. Such an operation procedure is required.

[Patent Document 1] Tokkaihei 9-114903

[Patent Document 2] Japanese Patent No. 2844281

Thus, if medical image output apparatuses characterized by different-forms of film sheet output are used together, the film operation procedure by the operator must be switched between different modes of operation so that film sheets are reversed in the case of the side face type apparatus, whereas the order of film sheets is changed in the case of the upper portion type apparatus. These work procedures are complicated and are likely to cause confusion. If an operation error such as omission of the step of reversing the film sheets occurs, the following problem may arise. Since the film sheet is transparent, the medical images can be observed from either the obverse or reverse side. Accordingly, if the medical image of a body part characterized by bilateral symmetry such as a right hand or a left hand has been formed, it will be very difficult to tell a right hand from a left hand.

For easy patient identification of the of the medical image, the patient ID or name of that patient is often overlaid as supplementary information on the medical image on the lower right portion of the film sheet or at a position that does not overlap an area of the subject. Further, when a plurality of film sheets are to be outputted for one patient, a numeral representing “order of image diagnosis/overall number of outputted sheets” such as “1/2” or “2/2” is overlaid as supplementary information, together with the patient ID. The supplementary information is located on the lower right in the case of a correct image or on the lower left in the case of a mirror image. Whether the medical image is a correct image or a mirror image can be identified by checking the position of such supplementary information or if text such as the patient name is reversed or not. However, when a large number of medical images have been outputted, checking the position of the supplementary information and the condition of text one by one is very complicated work.

To solve these problems, it may be possible to reverse the medical image for outputting or to change the order of outputting. However, the image reversing method described in Patent Document 2 provides a method for reversing in response to instructions by the doctor in charge of image diagnosis, or in response to the type of recording medium. In the presence of medical image output apparatuses having different forms of outputting, automatic reversing in response to different forms of outputting cannot be implemented. Further, in the form of outputting described in Patent Document 1, the order of patients for outputting is changed, but this method fails to meet the requirements, for example, when a plurality of medical images created for the same patient are to be diagnosed in chronological order, and thus the order of outputting must be rearranged for the same patient.

As another problem, in a large hospital, for example, there are a large number of outputted film sheets and it often happens that several image-diagnosis doctors share one medical image output apparatus, and if film output commands from plural image-diagnosis doctors concentrate at one time, film sheets are accumulated according to the output order and film sheets outputted by different image diagnosing doctors are mingled together in a film tray, and it is time consuming for each doctor to pick the own film sheets. Generally, a name, ID (identification information provided to identify an individual patient) of a patient whose medical images were taken, an image-diagnosis order and a total output number for one patient are outputted on the film as supplementary information together with a medical image. Accordingly, films of own output can be searched from among the accumulated films by virtue of this supplementary information, however it is complicated because a patient name needs to be confirmed for each film sheet.

Especially, in the case of imaging for examination such as CT (Computed Tomography) or MRI (Magnetic Resonance Imaging), the number of imaging is quite large compared to CR (Computed Radiography), and therefore it is difficult to segregate the films from among the mixed films especially when a few CR medical images are mingled among large numbers of CT or MRI medical images.

Further, in a medical image output apparatus, the order of output follows the order of input and subsequent film is laid on the preceding films on the tray. Accordingly, when films are outputted from a medical image outputting apparatus of the structure shown in FIG. 10(a), the order of medical images from the top (hereinafter referred to as film order) is opposite to the image-diagnosis order as shown in FIG. 10(b). When the images are arranged on a viewing light panel for observation, they are often placed according to image diagnosis order from left to right as shown in FIG. 10(c) and if the film sheets are outputted in an output form shown in FIG. 10(b), reordering of the individual films is needed. The reordering is, however, a considerably complicated work because the number of resulting sheets is large in CT or MRI, as described above.

### SUMMARY OF THE INVENTION

The object of the present invention is to unify the output form of the film sheets of each medical image output apparatus connecting to a plurality of medical image output apparatuses each having different output form and to facilitate the sorting operation of the outputted film sheets.

1. A medical image output system; comprising a plurality of medical image output apparatuses for forming a medical image of a patient on a film sheet and for outputting the film sheet on which the medical image is formed, in different output forms and a controlling section to control the plurality of medical image output apparatuses, wherein the controlling section further comprises an output form storage section to store the output form information of the plurality of medical image output apparatuses, a standard form storage section to store a standard form information defining a standard output form, and an output control section to output the film sheet from each medical image output apparatus by executing at least one of a reversing process to reverse the medical image to be outputted, to obtain a correct image or a mirror image, and a rearranging process to rearrange the output order of the medical images, so that the film sheet is outputted in the standard output form, from each medical image output apparatus, based on the stored output form information and the stored standard form information of each medical image output apparatus.

2. The medical image output system of claim 1, wherein the standard output form is such that, when film sheets outputted from each medical image output apparatus are viewed from the top of the film sheets, medical images formed on the film sheets are correct images, and the film sheets on which the medical images are formed are piled in an image diagnosis order of the medical images.

3. The medical image output system of claim 1, wherein the standard output form is selected among the output forms of the plurality of medical image output apparatuses.

4. The medical image output system of claim 1, wherein the output control section outputs supplementary information with the medical image, on the film sheet.

5. The medical image output system of claim 1, wherein a glossiness of the film sheet is almost same on both sides.

6. The medical image output system of claim 4, wherein the film sheet the glossiness of which is almost same is a film sheet for heat development, containing a photosensitive layer on a substantially transparent substrate.

7. A medical image output method in a medical image output system including a plurality of medical image output apparatuses for outputting a film sheet on which a medical image is formed, in different forms, comprising the steps of storing an output form information of the plurality of medical image output apparatuses in an output form storage section, storing a standard form information defining a standard output form in a standard form storage section, and outputting the film sheet from each medical image output apparatus by executing at least one of a reversing process to reverse the medical image to be outputted, to obtain a correct image or a mirror image and a rearranging process to rearrange the output order of the medical images, so that the film sheet is outputted in the standard output form, from each medical image output apparatus, based on the stored output form information and the stored standard form information of each medical image output apparatus.

8. The medical image output method of claim 7, wherein the standard output form is selected among the output forms of the plurality of medical image output apparatuses.

9. A medical image output apparatus outputting a medical image of a patient onto a film sheet, comprising an output device to output the medical image and supplementary information of the medical image onto the film sheet and to eject the film sheet and an output control device to execute a reverse process of the medical image and the supplementary information to obtain a correct image or a mirror image, to produce different output forms between cases in which plural medical images are outputted and a single medical image is outputted, and to output the reversed medical image and the reversed supplementary information by the output device.

10. The medical image output apparatus of claim 9, wherein, when plural medical images are outputted for one patient, the output control device executes a rearranging process to rearrange an output order of medical images so as to make an order of the medical images formed on outputted film sheets accord to an image diagnosis order, while the medical images formed on the film sheets are viewed as correct images, and outputs the film sheets in the rearranged output order by the output device.

11. The medical image output apparatus of claim 9, wherein a glossiness of the film sheet is almost same on both sides.

12. The medical image output apparatus of claim 11, wherein the film sheet the glossiness of which is almost same is a film sheet for heat development, containing a photosensitive layer on a substantially transparent substrate.

13. A medical image output method for outputting a medical image of a patient and supplementary information of the medical image onto a film sheet, comprising steps of executing a reverse process of the medical image and the supplementary information to obtain a correct image or a mirror image, to produce different output forms between cases in which plural medical images are outputted and a single medical image is outputted and outputting the reversed medical image and the reversed supplementary information onto a film sheet by a output device.

The invention standardizes the form of the film sheet outputted from each medical image output apparatus in the presence of a plurality of medical image output apparatuses characterized by different forms of output. Accordingly, the same invention standardizes the film operation procedure for an operator to improve work efficiency.

The invention standardizes the output format in such a way that the medical image formed on the outputted film sheet is a correct image and the film sheets with medical images formed thereon are outputted in the order of image diagnosis. Accordingly, the operator takes out the film sheets having been outputted and arranges the film sheets one by one in the light box. This simple procedure allows correct medical images to be arranged in the order of image diagnosis, with the result that work efficiency is improved.

The invention allows the supplementary information, together with the medical image, to be outputted on the film sheet.

The film sheet having almost the same glossiness on both sides is used. When the medical image has been reversed, the surface with the image formed thereon is not always the surface used for image diagnosis. Use of the film sheet having a small difference in glossiness does not give a sense of incompatibility to the doctor in charge of image diagnosis, independently of the surface from which image diagnosis is made.

According to the invention described in claim 5, a film sheet for heat development can be used as the film sheet having almost the same glossiness on both sides is used.

The invention makes the output format between multiple output and single output differ from each other and the operator can easily segregate a group of film sheets of multiple output from a film sheet of single output because of the difference of the output form. Further, by reversing the supplementary information as well as the medical image, output form differs, and therefore, a boundary of the film sheets between multiple output and single output can be easily found due to the position of the supplementary information on the film sheet and it facilitates the relevant work.

In the case of multiple output, because images formed on film sheets are correct image and outputted to be piled in the diagnosis order, the operator takes out the film sheets having been outputted and arranges the film sheets one by one in the light box. This simple procedure allows correct medical images to be arranged in the order of image diagnosis, with the result that work efficiency is improved.

### BRIEF DESCRIPTION OF THE DRAWINGS

FIG. 1 is a diagram representing the internal configuration of medical image output system 100.

FIG. 2 is a diagram representing the internal configuration of controller 20.

FIG. 3 is a diagram representing an example of data configuration in output form table 221.

FIG. 4 is a diagram representing an example of data configuration in standard form table 222.

FIG. 5 (a) is a diagram showing medical image output apparatus 50a as a side face type apparatus, and FIG. 5 (b) is a diagram showing medical image output apparatus 50b as a upper portion type apparatus.

FIG. 6 is a diagram showing the internal configuration of medical image output apparatuses 50a and 50b.

FIG. 7 is a flowchart showing the processing of output control to be implemented by controller 20 (The first embodiment).

FIG. 8 is a flowchart showing the processing of output control to be implemented by controller 20 (The second embodiment).

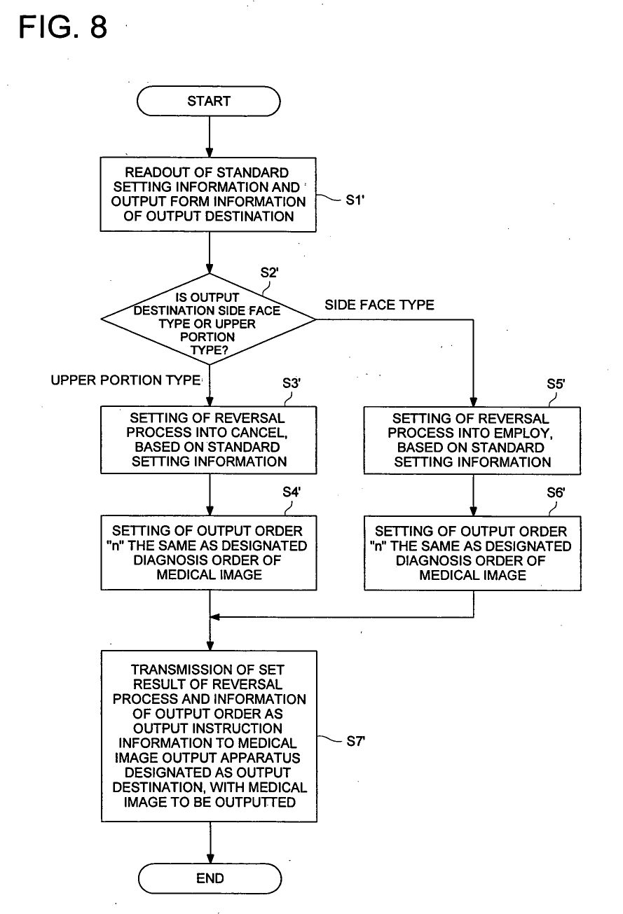

FIG. 9 is a flowchart illustrating processing of film output implemented by the medical image output apparatus 50a.

FIG. 10 is a diagram representing a form of film output performed by medical image output apparatus 50a.

FIG. 11 is a flowchart illustrating processing of film output implemented by medical image output apparatus 50b as a upper portion type apparatus.

FIG. 12 is a diagram representing a form of film output performed by medical image output apparatus 50b.

FIG. 13 is a diagram representing a form of film output performed by medical image output apparatus 50a and 50b.

FIG. 14 is a diagram showing an example of the configuration provided with a plurality of trays wherein (a) shows medical image output apparatus 50a, and (b) medical image output apparatus 50b.

FIG. 15 (a) is diagram showing the medical image output apparatus as a side face type apparatus and FIGS. 13 (b) and (c) shows the film output form thereof.

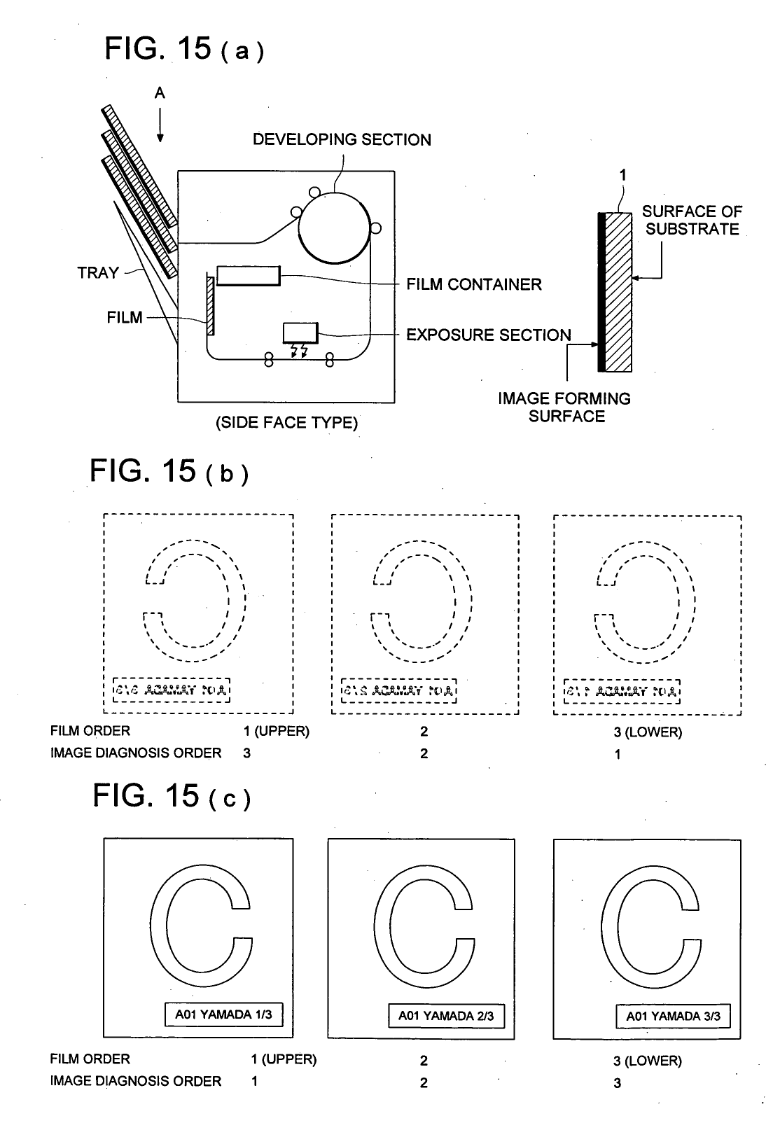

FIG. 16 (a) is a diagram showing a prior art medical image output apparatus as an upper portion type apparatus and FIGS. 14 (b) and (c) shows the film output form thereof.

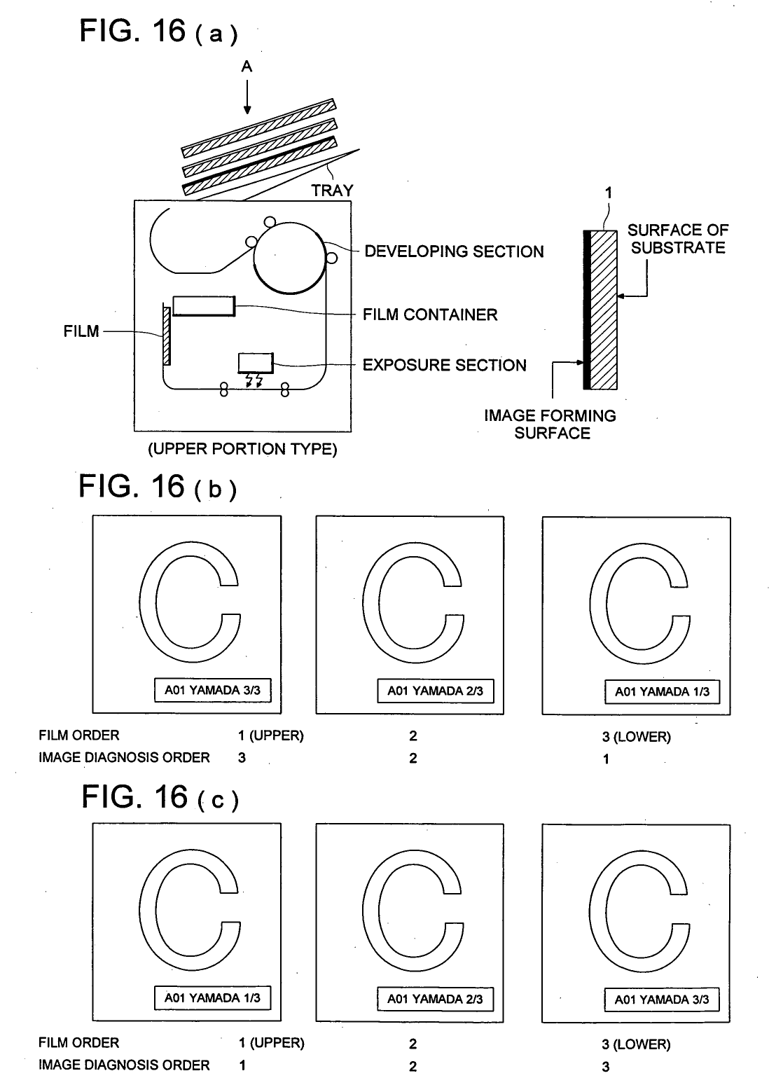

FIG. 17 is a flowchart explaining a film output process implemented by medical image output apparatus 50.

FIGS. 18 (a) and 18(b) are views showing examples of output format of medical images and their supplementary information.

FIG. 19 is a view showing an example of a group of typical film sheets outputted in the film output process.

FIG. 20 is a view showing a group of piled outputted film sheets.

### DETAILED DESCRIPTION OF THE PREFERRED EMBODIMENT

As preferred embodiments of the present invention, the following three embodiments will be explained.

### (1) The First Embodiment

With reference to the present embodiment, the following describes an example of unifying the film output form in a single system containing a plurality of medical image output apparatuses, each output form of which is not the same. This unification is achieved by controlling the reversing of the medical image and rearrangement of the order of the medical image output so as to make the output form to be the standard form which has been preset as a standard output form (when the film sheet is viewed as it is ejected onto the tray, the medical image formed on the film sheet is a correct image and when a plurality of medical images are continuously outputted, the order of the arrangement of the medical images formed on the film sheet conforms to the image diagnosis order of medical images), in any of the medical image output apparatuses.

### (2) The Second Embodiment

With reference to the present embodiment, the following describes an example of unifying the film output form in a system containing medical image output apparatuses of the upper portion type and the side face type having different output forms. This unification is achieved by controlling the reversing of the medical image and rearrangement of the order of the medical image output so as to make the output form to be the standard form of medical image output apparatuses of the upper portion type, in any of the medical image output apparatuses.

### (3) The Third Embodiment

In this embodiment, explained will be an example of controlling a reverse process of the medical images and their supplementary information to produce different output forms between the cases in which multiple medical images are outputted for one patient and a single medical image is outputted for one patient, and further, of controlling a replacing process to replace the output order of medical images so as to make the sequence to accord to the image-diagnosis order while the medical images formed on plural outputted sheets of film are viewed as correct images.

### The First Embodiment

Depending on the type of the film material, gloss may occur on the substrate surface or the emulsion surface which is the image forming surface. Some doctors prefer greater glossiness, while others prefer lesser glossiness. In the present invention, a mirror image which reverses a medical image or a correct image without reversing a medical image is outputted to the film sheet so as to maintain a standard form in response to the film output form of each medical image output apparatus. Accordingly, image diagnosis is not always performed from the surface on which the image is formed and image diagnosis may be conducted from the substrate. Specifically, if there is a difference in glossiness on both surfaces of the film sheet, it is not necessarily guaranteed that the image diagnosis is conducted from the surface having the glossiness preferred by a specific doctor and the requirements of individual doctor cannot always be met. Thus, if the present invention is utilized when the film sheet with minimal difference in glossiness on both sides is employed, free control of the film output form can be provided independently of the glossiness, because the glossiness of the film sheet is almost the same, even when image diagnosis is conducted from either the substrate surface or the surface with an image formed thereon. The following describes the present embodiment, with reference to an example of a dry medical image output apparatus (a so-called dry imager) which outputs medical images, wherein a film sheet for heat development is used as a film sheet having almost the same glossiness on both sides.

The structure of the system will be described first.

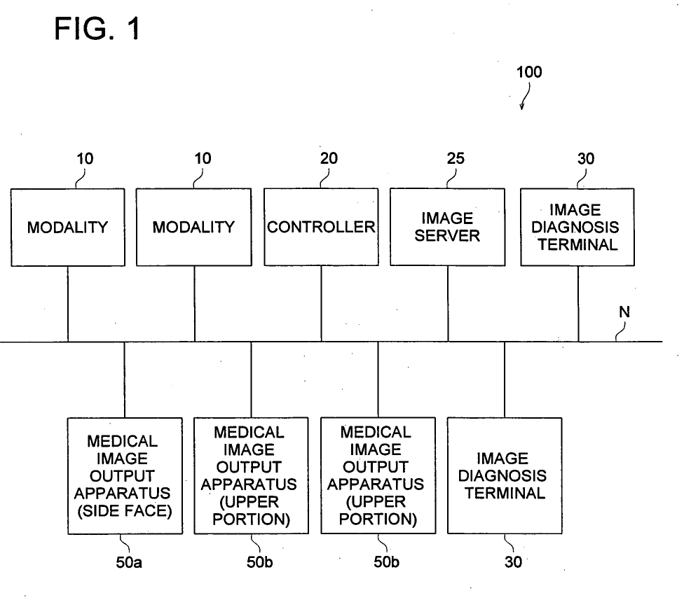

FIG. 1 shows the system configuration of medical image output system 100 according to the present embodiment. As shown in FIG. 1, medical image output system 100 is connected with modality 10, controller 20, image server 25, image diagnosis terminal 30 and medical image output apparatuses 50a and 50b through network N so that mutual communication is possible. FIG. 1 only shows an example of medical image output system 100 to which the present invention is applied and there is no restriction to the number of installed constituent apparatuses and their place of the installation.

The following describes each apparatus.

Modality 10 is an image generation means for generating digital data from medical images obtained by imaging a patient. An image acquiring apparatus acquiring an image by employing X-rays for imaging, scanning the X-rayed image recorded on a stimulable phosphor plate and generating images in the form of digital data, such as CR (Computed Radiography) and CT (Computed Tomography) apparatus is usable as modality 10, as well as such as MRI (Magnetic Resonance Imaging) and ultrasonic imaging apparatus, without being restricted to an X-ray apparatus.

An image acquiring apparatus using a flat panel detector (hereinafter referred to as “FPD”), instead of the stimulable phosphor plate, can also be used. An FPD is composed of a two-dimensional arranging radiation detecting devices to generate electrical charges conforming to the intensity of the applied radiation, and capacitors for accumulating the electrical charge generated by the radiation detecting devices, which is for example disclosed in Tokkaihei 6-342098. Thus an FPD captures the X-ray image of a subject and outputs it as electrical signals.

As another image generation means, a reading apparatus for only a cassette can be installed in medical image output system 1. When an image is captured using a cassette with a built-in stimulable phosphor plate, this reading apparatus scans the X-ray image recorded in the cassette and generates the image in the form of digital data. It is also possible to use a film digitizer capable of scanning the medical image outputted to the film sheet and reading it as digital data.

Modality 10 scans the medical image of a patient having been imaged and applies a reading process to generate the digital data. It then writes the modality number assigned to the modality as identification information for identifying an individual modality, in the header area of the generated medical image, and forwards it to controller 20.

Controller 20 controls the process of medical image generation by modality 10, and acquires the medical image having been generated. Then various forms of information, including patient information on the patient for whom a medical image has been captured and imaging information on the step of imaging for image capturing, are written in the header area of the medical image, and which are attached to the medical image as supplementary information by controller 20. Further, controller 20 generates output instruction information regarding film output of the medical image of medical image output apparatus 50a or 50b, and sends this output instruction information to medical image output apparatuses 50a and 50b, together with the medical image to be outputted, whereby controller 20 controls the film output form of medical image output apparatuses 50a and 50b.

Controller 20 stores the imaging order information issued for every imaging operation for examination. Based on the imaging order information, controller 20 controls the processing operation ranging from generation of the medical image to the storage thereof. The imaging order information can be defined as information specifying the order (request) for imaging, such as patient information on the patient to be shot, and imaging information showing conditions on imaging. At the request of the doctor, this information is generated in the hospital information control system (hereinafter referred to as HIS; Hospital Information System) and the radiographic section information control system (hereinafter referred to as RIS; Radiography Information System), and is sent to controller 20 via the hospital LAN (Local Area Network). When the medical image is stored in the form of such a database, controller 20 seeks the imaging order information corresponding to the medical image obtained from modality 10 and writes, into the header area of the medical image, the information having the same contents as those of the imaging order information having been found out and stores this information after associating the medical image with the imaging order information. This step is carried out to segregate each medical image from other medical images and to enable identification of the patient who has been imaged and the imaging condition at that time.

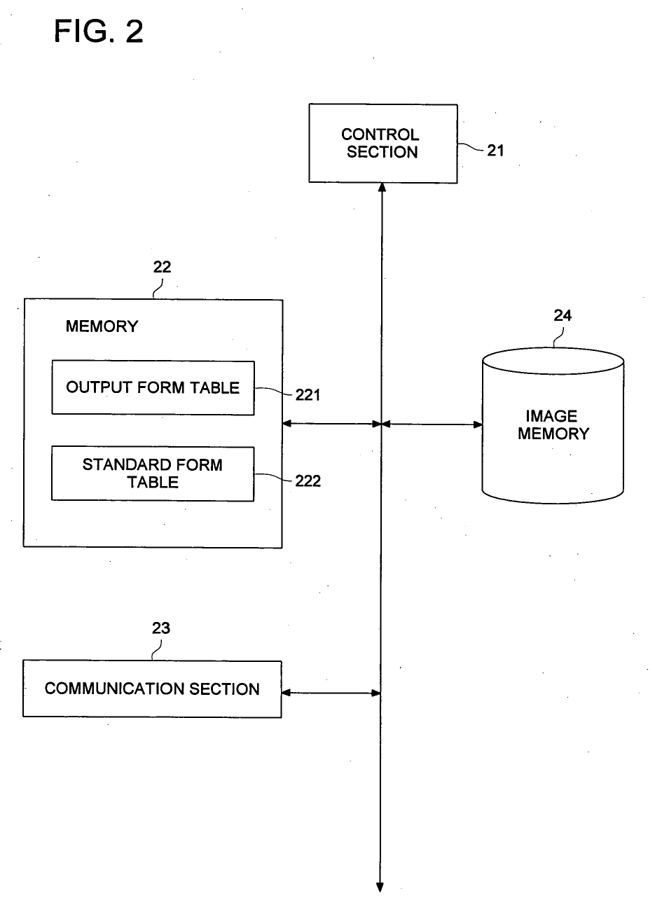

FIG. 2 shows schematically the internal structure of controller 20.

As shown in FIG. 2, controller 20 is composed of control section 21, memory 22, communication section 23 and image memory 24.

Control section 21 is composed of a CPU (Central Processing Unit), a RAM (Random Access Memory) and others. A system program stored in memory 22, the output control processing program of the present invention and others are developed from the RAM and control section 21 implements centralized control of each section according to the program developed from the RAM.

In the processing of output control, upon receipt of the instruction information of the medical image film output from image diagnosis terminal 30, reference is made to output form table 221 (details to be described later) stored in memory 22, to read out the information on the output form of medical image output apparatus 50a or 50b defined as an output destination (hereinafter referred to as “output form information”). At the same time, reference is made to standard form table 222 (details to be described later) to read out the information on output form set as the standard output form (hereinafter referred to as “standard form information”). Then based on the aforementioned read-out information, presence or absence of the reversing process of the medical image and supplementary information, as well as the output order are set in such a way that the film output form will be a standard form. Then the information on setting of presence or absence of the reversing process and the output order as the output instruction information, together with the medical image to be outputted, is sent to medical image output apparatus 50a or 50b defined as the output destination, through communication section 23. That is, output control means is provided by collaboration between control section 21 and output control processing program.

Memory 22 is composed of a magnetic or optical recording medium, a semiconductor memory or other means, and stores various control programs such as a system program and an output control processing program, and the data to be processed by these programs. Memory 22 also stores the parameters used in various steps of processing, and the data obtained as a result of such processing.

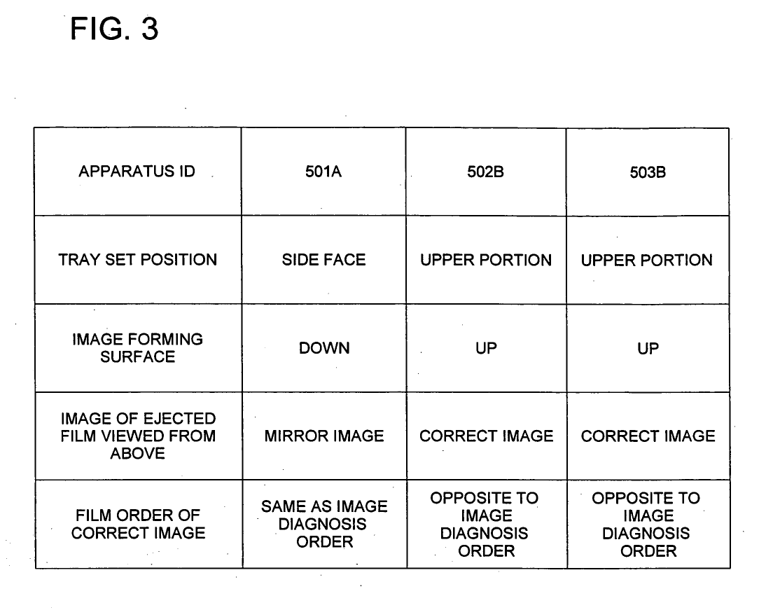

Memory 22 also stores output form table 221 and standard form table 222. Output form table 221 is a table containing the output form information of medical image output apparatuses 50a and 50b connected to medical image output system 100. Output form table 221 incorporates the output form information of medical image output apparatuses 50a and 50b, wherein this information is associated with the apparatus ID (e.g., “501A” assigned to medical image output apparatus 50a) inherently assigned in order to identify medical image output apparatuses 50a and 50b, as shown in FIG. 3. The output form information includes the information on the tray installation position (e.g. “side face”, “upper portion”), the location of the image formed surface (the surface of the film sheet with the medical image formed thereon) of the film sheet ejected onto the tray (e.g. “up” when ejected so that the image formed surface is located upward, “down” when ejected so that the image formed surface is located downward), the image formed on the film sheet when viewed from above as ejected on the tray (e.g., “correct image” if it is a correct image, and “mirror image” if it is a mirror image) and the order of the medical images when a plurality of sheets have been continuously outputted (order of the film sheets from the top, called “film order”, e.g., “same as image diagnosis order” when the order is the same as the order of image diagnosis of medical images and “opposite to image diagnosis order” when the order is opposite to the order of image diagnosis). That is, memory 22 provides an output form storage means.

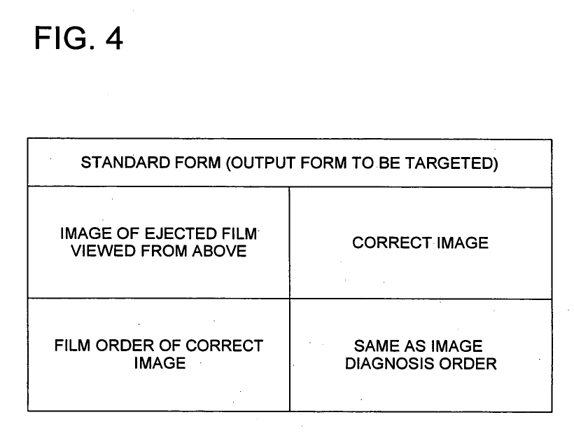

Standard form table 222 is a table defining the standard form. The standard form is an output form to be targeted when unifying the output form of medical image output apparatuses 50a and 50b. Standard form table 222 incorporates the setting information of an image formed on the film sheet when viewed from above as ejected onto the tray as shown in FIG. 4 (e.g., “correct image” if it is set to be a correct image, and “mirror image” if it is set to be a mirror image) and the order of film sheets when a group of the film sheets ejected are viewed so that the medical images formed on these film sheets are correct images, in cases where a plurality of sheets have been outputted continuously (e.g., “same as image diagnosis order” when the setting has been made to be the same as the order of image diagnosis of medical images; and “opposite to image diagnosis order” when the setting has been made to get the order opposite to the order of image diagnosis). The contents of the standard form can be set appropriately. That is, memory 22 provides an output form storage means.

Communication section 23 is composed of an NIC (Network Interface Card), a modem and others, and performs data communication with such apparatuses on communication network N as modality 10, image server 25, image diagnosis terminal 30, and medical image output apparatuses 50a and 50b.

Image server 25 is composed of a large-capacity image storage means. Medical images acquired by modality 10 and provided with supplementary information by means of controller 20, is stored in this image storage means in the form of a database (hereinafter referred to as “DB”), whereby an image DB is constructed to perform medical image control.

Image diagnosis terminal 30 is equipped with a display means and is a terminal used by doctors to observe the medical image for image diagnosis. Image diagnosis terminal 30 sends an inquiry to image server 25 to acquire the medical image, which has been instructed by the doctor to be displayed, and then this medical image is displayed on the aforementioned display means. If the medical images to be outputted onto film sheets are specified by the doctor in a specific order in which medical images will be viewed, image diagnosis terminal 30 generates and sends, to controller 20, the instruction information to the effect that medical images will be outputted in the specified order.

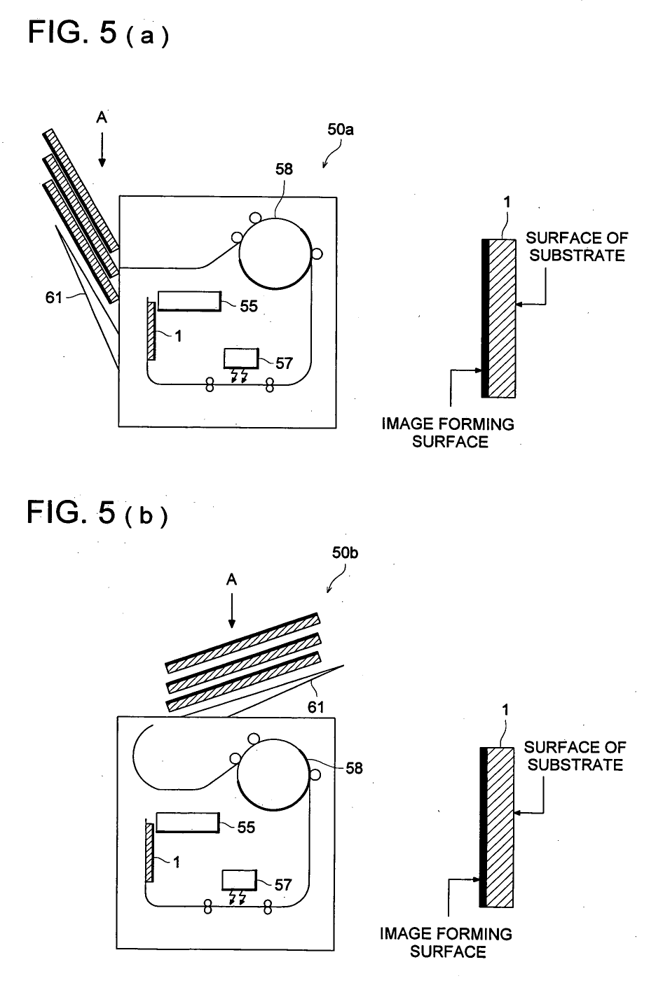

Medical image output apparatuses 50a and 50b generate medical images on film sheets based on the medical image data, and output them. Medical image output apparatus 50a is a side face type apparatus wherein tray 61 is mounted on a side face of the apparatus body, as shown in FIG. 5 (a). Medical image output apparatus 50b is an upper portion type apparatus wherein tray 61 is mounted on the upper portion of the apparatus body, as shown in FIG. 5 (b).

Medical image output apparatuses 50a and 50b have the same function of each component, except for the installation position of tray 61. The following explanation is based on the same reference numerals assigned to the same parts. Each of medical image output apparatuses 50a and 50b are composed of film container 55 for storing and supplying film sheet 1 made of the photosensitive and heat-sensitive recording material (hereinafter referred to as “photothermally sensitive material”), exposure section 57 for applying a laser beam onto film sheet 1 to provide exposure and to form a latent medical image, developing section 58 for heating film sheet 1 subsequent to the exposure and visualizing (developing) the latent image formed by the exposure and tray 61 for holding and storing developed and ejected film sheet 1.

Film sheet 1 is a substrate (also called a support layer) of a PET (polyethylene terephthalate) coated with emulsion containing a photothermally sensitive material to form a photosensitive layer. Further a protective layer can be provided on the top surface of the photosensitive layer.

When a medical image is formed on film sheet 1, exposure is applied to the surface of a photosensitive layer formed thereon. More specifically, a medical image is always formed on the surface of the photosensitive layer (the surface of the photosensitive layer with a medical image formed thereon is hereinafter referred to as “image formed surface”). Thus, in the case of medical image output apparatus 50a shown in FIG. 5(a), a conveyance path is configured so that film sheet 1 is ejected after a round traveling inside the apparatus. Accordingly, film sheet 1 is ejected to tray 61 with the image formed surface facing downward. In the case of medical image output apparatus 50b shown in FIG. 5 (b), the conveyance path is so designed that film sheet 1 is reversed and ejected after a round traveling inside the apparatus. Accordingly, film sheet 1 is ejected to tray 61 with the image formed surface facing upward.

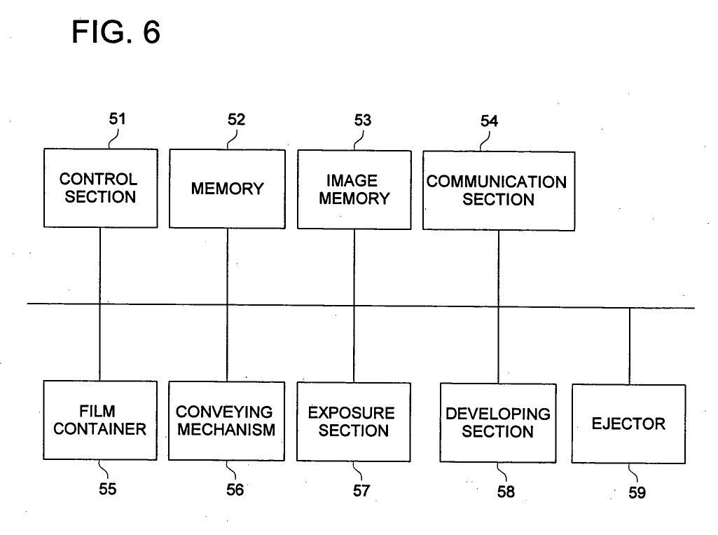

Referring to FIG. 6, the following describes the internal structure of medical image output apparatuses 50a and 50b. As described above, the components are the same in both medical image output apparatuses 50a and 50b, and therefore, the same parts will be assigned the same reference numerals in FIG. 6. Medical image output apparatus 50a will be taken as an example for the following explanation of each component.

As shown in FIG. 6, medical image output apparatus 50a is composed of control section 51, memory 52, image memory 53, communication section 54, film container 55, conveying mechanism 56, exposure section 57, developing section 58 and ejector 59.

Control section 51 reads out various programs stored in memory 52 and film output processing programs of the present invention, and provides centralized control of the operation of various sections according to the control program.

In the film outputting step, when the medical image to be outputted, together with output instruction information, is inputted from controller 20 through communication section 54, according to the output instruction information, reversing is not performed if reversing is set to be canceled. If reversing is set to be employed, reversing is carried out so that the inputted medical image with the supplementary information thereof will become a correct image or a mirror image. Further, rearrangement process is conducted to the output order of the inputted medical images so as to output them in the preset order. In the present embodiment, the medical images are inputted in the preset output order in controller 20, and therefore, there is no need of the rearrangement process. The image data for output is then generated and outputted to exposure section 57, wherein this image data for output has been obtained by arranging the medical image and the supplementary information thereof reversed (or not reversed) in the preset output order, according to a predetermined output format. At the same time, instructions are given to each section to form an image so that the medical image and the supplementary information thereof are outputted onto film sheet. On the output format, the image area where an image is formed and the supplementary information area where a text of the supplementary information is formed are designated.

Memory 52 is composed of a magnetic or optical recording medium, a semiconductor memory and other means, which is used to store the parameters used by various control programs or for processing, as well as the data including the results of processing.

Image memory 53 stores the medical image data, to be outputted, having been inputted through communication section 54.

Communication section 54 is composed of an interface such as a NIC or a modem, and is used for data communication with various apparatuses on communication network N such as modality 10, controller 20, image diagnosis terminal 30 and medical image output apparatuses 50a or 50b. Communication section 54 communicates with controller 20. When communication section 54 has received the data of medical image to be outputted, it outputs the medical image data to image memory 53.

Film container 55 is composed of a tray to accommodate unexposed film sheets 1 placed one on top of another and a pickup mechanism for picking up film sheets 1 from the tray and sending them to the conveyance path. In response to the instructions from control section 51, film container 55 sends film sheets stacked in the tray to the conveyance path.

Conveying mechanism 56 is equipped with a plurality of paired conveying rollers arranged along the conveyance path for film sheets 1. Film sheet 1 fed from film container 55 into the conveyance path is sequentially conveyed to exposure section 57, developing section 58 and ejector 59 at a predetermined speed.

Exposure section 57 is composed of a laser oscillator to oscillate laser beams aimed onto film sheet 1, a light intensity modulation section to change the amount of the laser beam oscillated by the laser oscillator, according to the medical image data to be visualized; a polygonal mirror for causing a laser beam to scan film sheet 1, a precise feeding mechanism and an optical system containing a condenser lens for condensing the laser beam and an fθ lens.

When film sheet 1 is fed from film container 55 to exposure section 57, a laser-beam is oscillated from the laser oscillator, and at the same time, medical image data are inputted into the light intensity modulation section. The light intensity modulation section allows the laser beam to be modulated according to the medical image data. The modulated laser beam is aimed at the polygonal mirror rotated at a predetermined speed. Scanning by the laser beam is thus carried out through reflection at a predetermined period perpendicular to the direction in which film sheet 1 is fed. This direction of scanning is called the main scanning direction. In the meantime, film sheet 1 is fed at a predetermined speed by a precise feeding mechanism in the direction of conveyance. Thus, the laser beam is applied over the entire surface of film sheet 1. The scanning direction in the direction in which film sheet 1 is conveyed is called the sub-scanning direction, in contrast to the aforementioned main scanning direction.

Developing section 58 is composed of a heated roller to heat film sheet 1 exposed by exposure section 57 and the opposing rollers which press film sheet 1 into close contact on the heated roller. The heated roller has a built-in heater and is formed in a cylindrical shape. Since film sheet 1 is kept on the outer periphery thereof for a predetermined heat developing time at a predetermined minimum heat development temperature or higher, the latent image formed on film sheet 1 via beam exposure is converted into a visible image.

Ejector 59 contains tray 61 and a film feeding mechanism (not illustrated). It feeds film sheet 1 heat-developed by developing section 58 and ejects film sheet 1 onto tray 61. Film sheets 1 ejected to tray 61 are sequentially placed on the film sheets having been outputted previously, one after another.

The following describes the operation of medical image output system 100.

Initially, describes will be the flow of processes ranging from generation of the medical image to storage thereof in medical image output system 100.

When the medical image is captured, imaging order information is shown in a tabulated list by controller 20. The imaging engineer selectively inputs the imaging order information for intended imaging, and checks the relevant patient and the imaging conditions. Then modality 10 starts imaging of the patient according to the imaging conditions. In modality 10, imaging is performed and medical image data are generated to be sent to controller 20. Upon receipt of the medical image from modality 10, controller 20 writes into the header area of the medical image, the information having the same contents as those of the selected imaging order information, and this information is then stored in image server 25.

As described above, image server 25 stores the medical images obtained by image capturing for medical examination, and these images are accumulated in it. Image diagnosis terminal 30 displays the medical images stored by image server 25. The medical images to be outputted are selected by the operator in the order of image diagnosis. Either medical image output apparatuses 50a or 50b is selected as a destination where medical images are to be outputted. After that, an operation is made to give the film output instruction, and instruction information is generated, to require that the medical images instructed to be outputted are outputted in the specified order for image diagnosis, by specified medical image output apparatus 50a or 50b. This instruction information is sent to controller 20. For example, when instruction operation has been made to require that four medical images captured for one patient are outputted on medical image output apparatus 50a, the instruction information contains the information such as the image ID of the medical image to be outputted, the order of image diagnosis thereof, the patient ID, the apparatus ID of medical image output apparatus 50a, and other data.

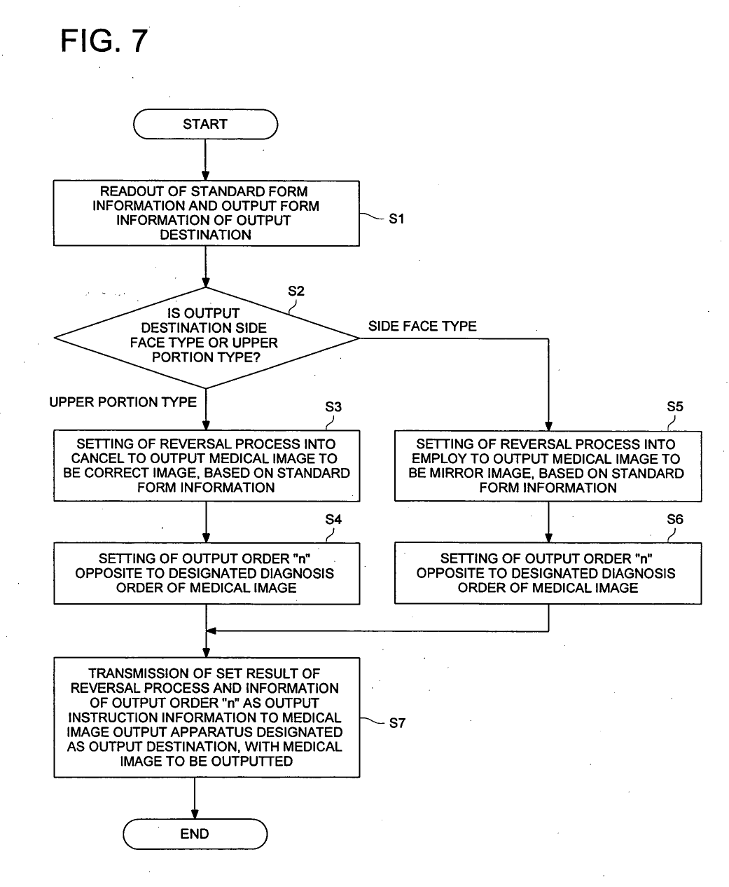

Referring to FIG. 7, the following describes the output control processing to be implemented by controller 20 having received the instruction information for film output.

In the output control processing shown in FIG. 7, standard form information is read out of the standard form table 222. Based on the instruction information received from image diagnosis terminal 30, the apparatus ID of the medical image output apparatus specified as the output destination is read out and then the output form information corresponding to the apparatus ID is read out of output form table 221 (Step S1). Based on the output form information having been read out, a determination is made whether the medical image output apparatus specified as the output destination is a side face type apparatus or an upper portion type apparatus (Step S2).

First, the following describes the case where a decision has been made that the apparatus is the upper portion type.

Based on the output form information having been read out, if determination has been made that the tray installation position is “upper portion”, the image formed surface is “up”, the film image is “correct image”, and the output destination is the upper portion type apparatus (Step S2; upper portion type apparatus), then the data of the medical image specified to be outputted based on the instruction information is acquired from image server 25. Whether or not the acquired medical image is that of the same patient is determined according to the patient ID written in the header area of the medical image and the supplementary information on patient name. Based on the standard form information read out from standard form table 222 and the aforementioned output form information having been read out, the employ/cancel state of reversing is set in order to ensure that the film output form will conform to the standard form, when the film sheet has been outputted by medical image output apparatus 50b as the upper portion type apparatus. According to the present embodiment, the image is set as a correct image when the film sheet has been ejected as in the standard form. Accordingly, the reversing process is set to the “cancel” state to ensure that the medical image or the supplementary information thereof will be a correct image, in response to the characteristics of the output form in the upper portion type apparatus (Step 3). This means that, in the case of the upper portion type apparatus, reversing is not performed.

After the employ/cancel state of reversing has been set, parameter “n” showing the order of outputting the medical images is set for each medical image, to ensure that the order will be opposite to the order specified as that for medical image diagnosis (Step S4). After that, the control advances to Step S7.

The following describes the case where the destination of output is the side face type apparatus.

In Step S1, if a decision has been made, based on the output form information having been read out, that the tray installation position is “upper portion”, the image formed surface is “up”, the film image is “correct image”, and the medical image output apparatus is the side face type apparatus (Step S2; side face type apparatus), then the data of the medical image specified as the data to be outputted based on the instruction information is acquired from image server 25. Based on the standard form information read out of standard form table 222 and aforementioned output form information having been read out, the employ/cancel state of reversing is set so as to ensure that the film sheet will be outputted in the standard form when the film outputting is carried out by medical image output apparatus 50a. In the present embodiment, the image, as the film sheet has been ejected in a standard form, is set as a correct image, and therefore, the process of reversing is set to the “employ” state to ensure that the medical image with the supplementary information thereof will become a correct image, in response to the characteristics of the output form of the side face type apparatus (Step S5). This means that reversing is carried out in the case of the side face type apparatus.

When the employ/cancel state of reversing has been set, parameter “n” representing the order of the output of medical images is set to ensure that the order will be the opposite to the one specified as the order of image diagnosis (Step S6). Then the control goes to Step S7.

In Steps S7, the employ/cancel state of reversing set for each medical image and information on output order “n”, together with the data of the medical image to be outputted, are sent to medical image output apparatus 50a or 50b specified as an destination of output, after which the process of step S7 is finished.

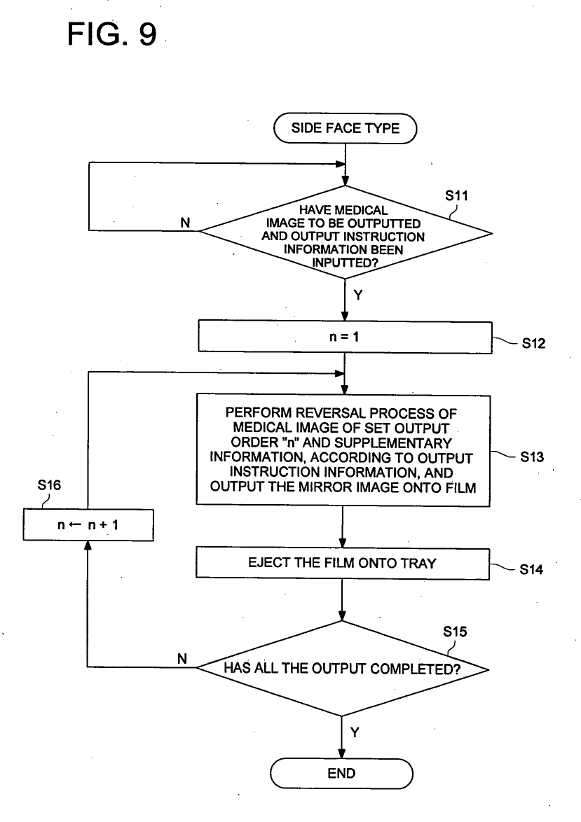

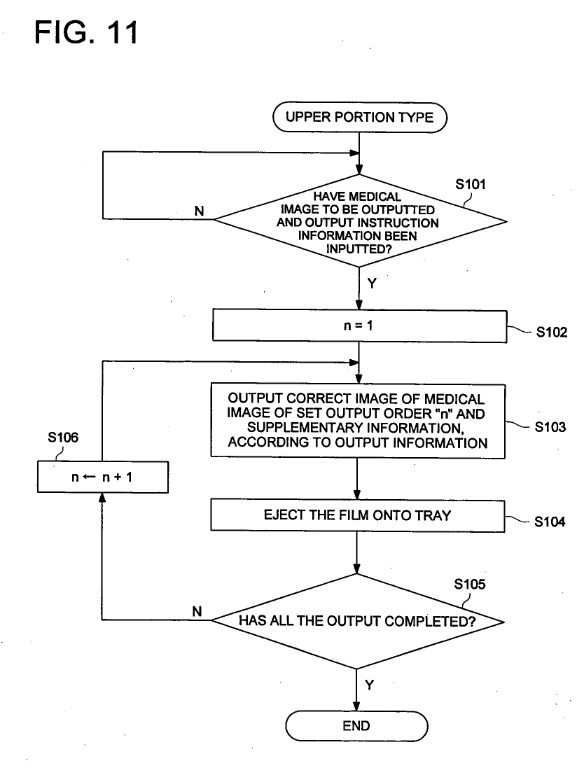

The following describes the processing of film output to be implemented in medical image output apparatus 50a or 50b, wherein the medical image has been received from the controller 20. FIG. 9 is a flowchart representing the process of film outputting in medical image output apparatus 50a as a side face type apparatus and FIG. 11 is a flowchart representing the process of film outputting in medical image output apparatus 50b as upper portion type apparatus.

Initially, the processing by medical image output apparatus 50a of the side face type will be explained.

In the processing of film output shown in FIG. 9, a decision is made to see if the medical image to be outputted, together with the output form information, has been inputted or not through communication section 54 (Step S11). If a decision is made that the medical image to be outputted and the output form information have been inputted (Step S11; Y), then the medical image having been inputted is stored in image memory 53 on a temporary basis, and the output order “n” preset for each medical image is set to “n=1” as an initial value, according to the output instruction information (Step S12). Here output order “n” is opposite to the order of image diagnosis in controller 20 which means that the setting is made in such a way that the last medical image in image diagnosis order will be the first one in order of output.

When output order “n” has been set, the medical images arranged in output order “n” are read out of image memory 53, after which reference is made to the output instruction information and if the medical image and the supplementary information thereof have been set to the “cancel” state of reversing, reversing is not applied. Reversing is applied if the medical image and the supplementary information thereof have been set to the “employ” state of reversing. In the case of a side face type apparatus, the medical image and the supplementary information thereof are set to the “employ” state by controller 20 in the aforementioned processing of output control (refer to FIG. 7), and therefore, reversing is carried out. A mirror image of the reversed medical image and the reversed supplementary information thereof, is laid out at a predetermined position according to a predetermined output format, and the image is formed on the film sheet by the process of exposure and development (Step S13). The supplementary information formed on the film sheet includes the patient ID, name of that patient, and numeral text representing the order of image diagnosis of the film sheet/the total number of sheets to be outputted for the patient.

After a mirror image of the medical image and the supplementary information thereof are formed on film sheet 1, film sheet 1 is ejected onto tray 61 by ejector 59 (Step S14). Then a decision is made to see whether or not outputting of film sheets has been completed for all the medical images having been inputted (Step S15). If outputting of film sheets has not yet been completed for all the medical images (Step S15; N), the parameter of output order “n” is incremented by “1” (Step S16), and the control process goes back to Step 13. More specifically, the parameter of output order “n” is advanced until the outputting of all film sheets is completed and the film sheet of the medical image according to the advanced output order “n” is ejected. Upon completion of outputting of all the film sheets for medical images, the present processing is terminated.

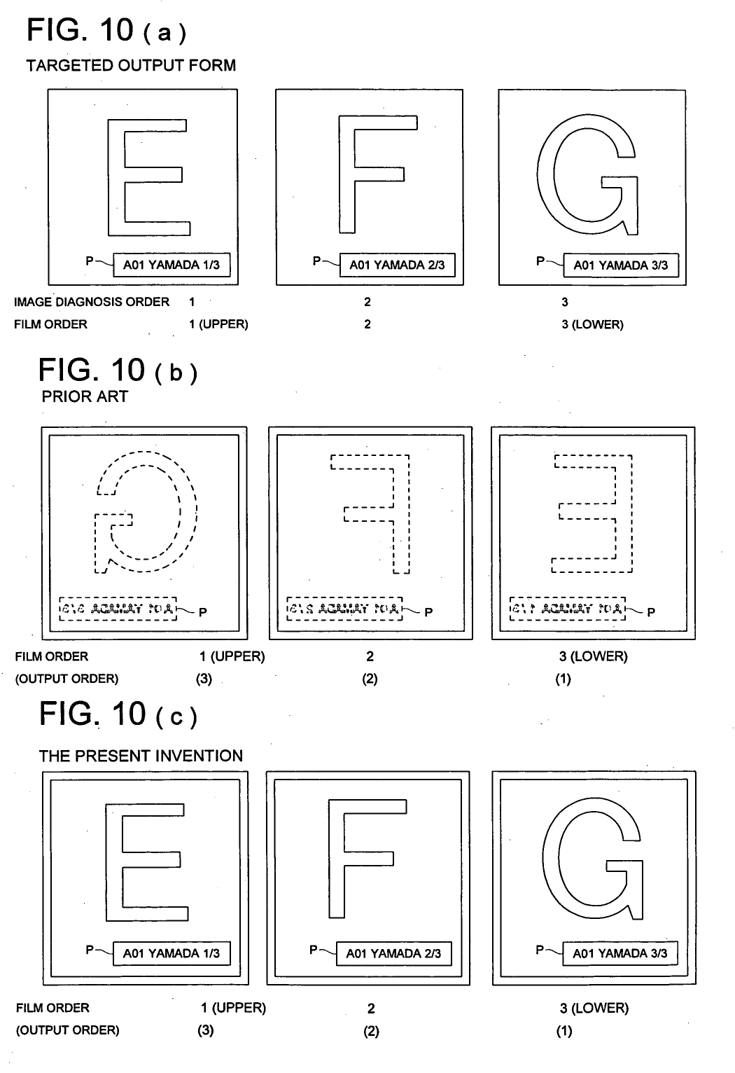

The output form of film sheets 1 ejected onto tray 61 and stored by the above film output processing will be explained by way of an example with reference to FIG. 10, when three images “E”, “F” and “G” are outputted on the film sheet. The film sheet enclosed in a white frame in FIG. 10 is shown as viewed from the surface opposite the image formed surface, namely, the surface of the substrate. A correct image is indicated when the text of “E”, “F” or “G” or supplementary information “p” is given by solid lines, and a mirror image is indicated when the text is given by dotted lines.

When “E”, “F” and “G” are specified to be outputted in that order, all the medical image film sheets stacked on the tray are correct images, and film sheets arranged in the same order as that of image diagnosis must be outputted, according to the standard setting, as shown in FIG. 10 (a), in such a way that the first top film sheet in a group of three film sheets stored on the tray by continuous outputting carries medical image “E”, the second one carries medical image “F” and the third one carries medical image “G”. In this case, supplementary information “p” is located at the lower right, and the text is represented as a correct image.

When medical images are outputted on the film sheet without any processing as in the prior art, the image formed surface is located downward in medical image output apparatus 50a of the side face type, while film sheets 1 are accumulated on tray 61. Thus, when a group of film sheets stored on tray 61 shown in FIG. 10 (b) are viewed from the top, the medical image is a mirror image, and the film sheets are arranged in the order opposite to the specified order of image diagnosis, in such a way that the top film sheet carries medical image “G”, the second one carries medical image “F” and the third one carries medical image “E”. Supplementary information “p” is located at the lower left, and the text is represented in the form of a mirror image.

According to the present invention, however, control is provided in such a way that, in response to the characteristics of the output form of medical image output apparatus 50a, the medical image and the supplementary information thereof are reversed, and outputting is performed in an rearranged order opposite to the specified order of image diagnosis. Thus, when a group of film sheets accumulated on tray 61 are viewed from the top, as shown in FIG. 10(c), the medical image is a correct image, and the film sheets are arranged in the same order as that of image diagnosis, in such a way that the top film sheet of the group carries medical image “E”, the second one carries medical image “F” and the third one carries medical image “G”. Supplementary information “p” is located at the lower right, and the text is represented in a correct image. This shows agreement with the targeted standard form (output form shown in FIG. 10 (a)).

The following describes the processing in medical image output apparatus 50b as an upper portion type apparatus.

In the film output processing shown in FIG. 11, a decision is made to see whether or not the medical image to be outputted, together with the output instruction information, has been inputted through communication section 54 (Step S101). If a decision is made that the medical image and the supplementary information thereof to be outputted have been inputted (Step S101; Y), the medical image having been inputted is stored in image memory 53 on a temporary basis and the output order “n” set on each medical image is set to “n=1” as an initial value, according to the output instruction information (Step S102). Here the output order “n” is set opposite to the order of image diagnosis in controller 20, and therefore, the medical image having the last order of image diagnosis is set to be the first order of output.

When output order “n” has been-set, the medical image having output order “n” is read out of image memory 53. Reference is then made to the output instruction information and if the medical image and the supplementary information thereof are set to the “cancel” state of reversing, reversing is not performed. Reversing is performed if the medical image and the supplementary information thereof are set to the “employ” state of reversing. In the case of the upper portion type apparatus, the medical image and the supplementary information thereof are set to the “cancel” state of reversing by controller 20 in the aforementioned output instruction information (refer to FIG. 7), so that reversing is not performed. The correct medical image and respective supplementary information are arranged at a predetermined position according to a predetermined output format, and are formed on the film sheet by the processing of exposure and development (Step S103). Similarly to the case of the side face type apparatus, the supplementary information formed on the film sheet includes the patient ID, name of that patient, and numeral text representing the order of image diagnosis of the film sheet/the total number of sheets to be outputted for the patient.

When correct images of the medical image and the supplementary information image are formed on film sheet 1, film sheet 1 is ejected onto tray 61 by ejector 59 (Step S104). A check is made to see whether or not film output has been completed for all the medical images having been inputted (Step S105). If all film sheets have not been outputted yet (Step S105; N), the parameter for the output order “n” is incremented by “1” (Step S106), and the control goes back to Step S103. More specifically, the parameter for the output order “n” is advanced until all film sheets have been outputted, and the film sheets of the medical images on the advanced output order “n” are outputted. Upon completion of outputting of all the medical image film sheets, the present processing is terminated.

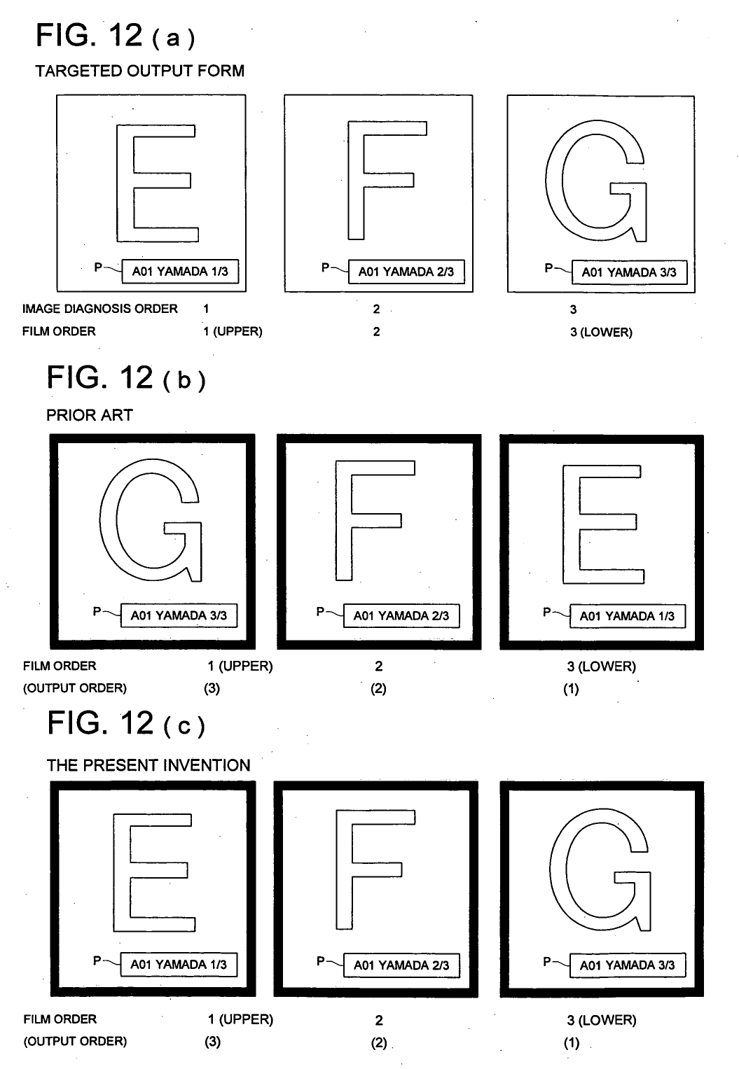

The output form of film sheet 1 ejected on tray 61 and stored by the aforementioned film output processing will be explained with reference to FIGS. 12(a)-12(c), when three images “E”, “F” and “G” are outputted onto film sheets, by way of an example. Film sheets enclosed in black frames in FIG. 12 are viewed from the surface opposite the image formed surface, namely, the surface of the substrate. A correct image is indicated when the text of “E”, “F” or “G” or supplementary information “p” is given by solid lines, and a mirror image is indicated when the text is given by dotted lines.

When “E”, “F” and “G” are specified to be outputted in this order, all the medical images of the film sheets stored on the tray are correct images, and film sheets arranged in the same order as that of image diagnosis must be outputted, according to the standard setting, as shown in FIG. 12 (a), in such a way that the first top film sheet in a group of three film sheets stored on the tray by continuous outputting carries medical image “E”, the second one carries medical image “F” and the third one carries medical image “G”. In this case, the supplementary information “p” is located at the lower right, and text is represented in a correct image.

When the medical image is outputted on the film sheet without any processing as in the prior art, the image formed surface is located upward in medical image output apparatus 50b of the upper portion type while the film sheets are accumulated on tray 61. Thus, when a group of film sheets stored on tray 61 shown in FIG. 12 (b) are viewed from the top, the medical image is a correct image, and the film sheets are arranged in the order opposite to the specified order of image diagnosis, in such a way that the first top film sheet carries medical image “G”, the second one carries medical image “F” and the third one carries medical image “E”. Supplementary information “p” is located at the lower right, and the text is represented in the form of a correct image.

According to the present invention, however, control is provided in such a way that, in response to the characteristics of the output form of medical image output apparatus 50b, the medical image and the supplementary information thereof are not reversed, and outputting is performed in a rearranged order opposite to the specified order of image diagnosis. Thus, a group of film sheets accumulated on tray 61 contain correct medical images as shown in FIG. 12 and the film sheets are arranged in the same order as that of image diagnosis, in such a way that the first top film sheet of the group carries medical image “E”, the second one carries medical image “F” and the third one carries medical image “G”. Supplementary information “p” is located at the lower right, and the text is represented in a correct image. This shows agreement with the targeted standard form (output form shown in FIG. 12 (a)).

As described above, in the presence of medical image output apparatuses 50a and 50b having different output forms, the present invention allows the output form to be made to conform to the standard form, when film outputting is performed by either of medical image output apparatus 50a or 50b by reversing the medical image to be outputted, and/or rearranging the order of output, in response to the characteristics of each of the output forms of medical image output apparatuses 50a and 50b′. Thus, the present invention standardizes the film operation procedure for the operator and improves the work efficiency.

When a plurality of medical images are continuously outputted, the order of output is rearranged so that the order of the film group viewed from the top will agree with the specified order of image diagnosis, when the medical image formed on each film sheet appears to be a correct image viewed from such a position. Accordingly, when the film sheets are arranged on a light box for image diagnosis, there is no need of performing a special film operation such as reversing of film sheets. Correct images of medical images can be arranged in the specified order of image diagnosis, by simply taking the film sheets stored on the tray 61, and placing the film sheets onto the light box sequentially one by one from the top.

In the case of CT, for example, when a plurality of tomographic images covering the pectoral region to the abdominal region are arranged, easier image diagnosis is ensured by arrangement in the specified order from the pectoral region to the abdominal region. However, CT involves a great number of film sheets, and therefore, a very complicated procedure is required to arrange them on a light box, while checking for the correct order of film sheets one by one. Thus, the present invention provides a more effective means for image diagnosis of medical images especially in CT or MRI, involving a great number of film sheets, wherein the order of image diagnosis is specified. Further, in the case of CR, past and present medical images must be outputted on film sheets in some cases to check variation with time. In this case, the present invention also provides an effective means for arrangement of images ranging from the past to the present.

When the present invention is applied, the image formed surface is not always used for image diagnosis. The substrate side may be used for this purpose. For example, the film sheets for heat development such as the SD-P of Konica Minolta Holdings, Inc., the DI-HL and DI-AL of Fuji Photo Film Co., Ltd. and others are generally characterized by a small difference in the glossiness on both surfaces, as compared to the prior art film sheets of wet processing (for wet type medical image output apparatus using a chemical processing solution). Thus, a doctor in charge of image diagnosis does not feel a sense of incompatibility, whether the image formed side or the substrate side is used for this purpose.

The description of the present embodiment refers to preferred examples of medical image output system 100 to which the present invention is applied, without the present invention being restricted thereto.

For example, in the above description, both medical image output apparatuses 50a and 50b are employed. The present invention can also be applied even when involved are further medical image output apparatuses having output forms other than that of the upper portion type or side face type apparatus. In this case, the output form information is stored in output form table 221 of controller 20, and reversing and/or rearrangement of the output order of medical images is controlled in response to the output form. Thus, the output form can be unified to a standard output form.

In the aforementioned embodiment, the standard output form is defined as the output form wherein the medical images recorded on the film sheets are correct images as viewed in the direction when the operator looks down at the film sheets ejected and stored in tray 61, and the order of image diagnosis of the medical image agrees with the order of film output when a plurality of sheets are outputted on a continuous basis. However, the standard form is not restricted thereto, just as long as the operator's film handling procedure is standardized. For example, it is also possible to implement control in such a way as to ensure that the medical images will be mirror images and the film sheets will be stored one by one from the bottom of the film group in the order conforming to the order of the medical images for image diagnosis. In either medical image output apparatus 50a or 50b, control is implemented to provide such an output form. This method of control allows the operator to take out a film group from the tray and to reverse the group all together, whereby the group of correct image film sheets arranged in order from the top can be obtained. Thus, the film handling procedure is standardized in this case as well.

In the above description, controller 20 is employed to control reversing of the medical image to be outputted or rearrangement of the output order in medical image output apparatus 50a or 50b. It is also possible to incorporate such an output control function into medical image output apparatus 50a or 50b.

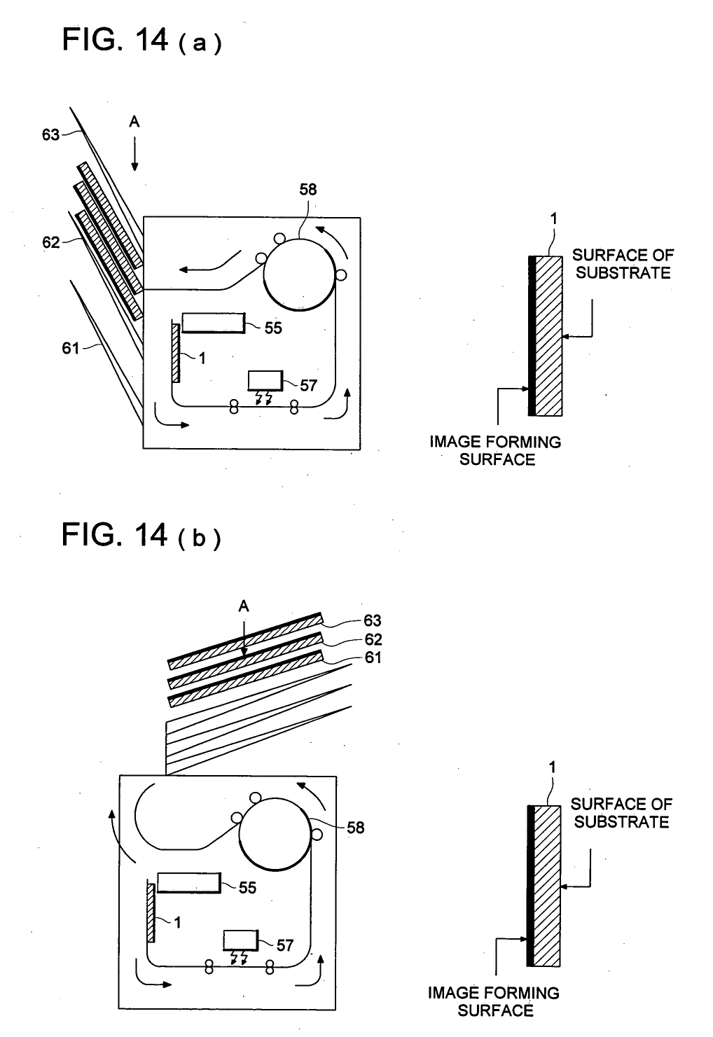

In the above description, only one tray is employed to retain and store the ejected film sheets in the present embodiment. The present invention is also applicable to the case where a plurality of trays 61 through 63 are provided as shown in FIG. 14, and film sheets are sorted onto trays 61 through 63 by ejector 59. FIG. 14 (a) shows an example where a plurality of trays 61 through 63 are installed on side face type medical image output apparatus 50a. FIG. 14 (b) shows an example where a plurality of trays 61 through 63 are installed on upper portion type medical image output apparatus 50b.

When a plurality of trays 61 through 63 are provided, in order to improve the efficiency in sorting work, trays 61 through 63 each are associated with the modality in some cases, in such a way that the CR medical images are placed in tray 61, the CT medical images are placed in tray 62, and the MRI medical images are placed in tray 63, for example. Alternatively, in some cases, trays 61 through 63 are associated with doctors in charge of image diagnosis, for example, in such a way that medical images to be handed by doctor “A” in charge of image diagnosis are outputted onto tray 61, medical images to be handed by doctors “B” and “C” in charge of image diagnosis are outputted to tray 62, and medical images to be handed by doctor “D” in charge of image diagnosis are outputted to tray 63.

When trays 61 through 63 are provided for each modality, the output instruction is given from image diagnosis terminal 30. Then the modality number is read out from the header area of the medical image to be outputted, in controller 20. The order of output “n” is rearranged and set so that the order is opposite to the order of image diagnosis specified in the medical images of the same modality number. Further, as described above, based on the output instruction information and standard form information, reversing of the medical image and the supplementary information thereof is controlled. This allows continuous film outputting for each modality in medical image output apparatuses 50a and 50b, and the film sheets are ejected onto trays 61 through 63 associated with the modality. Thus, the output form conforms to the standard form.

When trays 61 through 63 are set for each image diagnosis doctor, the information on authorized doctor of image diagnosis, together with the image ID of the medical image to be outputted is sent to controller 20 by control in image diagnosis terminal 30. In controller 20, output order “n” is rearranged and set to ensure that the order is opposite to the specified order of image diagnosis in the medical image corresponding to each image diagnosis doctor. As described above, based on the output instruction information and standard form information, reversing of the medical image and the supplementary information thereof is controlled. This allows continuous outputting of film sheets for each doctor in charge of image diagnosis in medical image output apparatuses 50a and 50b, and the film sheets are ejected onto trays 61 through 63 associated with the image diagnosis doctor. Thus, the output form conforms to the standard form.

The detailed configuration and detailed operation of medical image output system 100 according to the present embodiment can be appropriately modified, without departing from the spirit of the present invention.

### The Second Embodiment

Explanation will be given focusing on the differences from the first embodiment, regarding the example of unification of film sheet output form into that of a medical image output apparatus of the upper portion type.

First, in the processing of output control, upon receipt of the instruction information of the medical image film output from image diagnosis terminal 30, reference is made to standard form table 222 stored in memory 22, to read out the information on the output form of medical image output apparatus 50a or 50b defined as a standard form (standard form information). At the same time, reference is made to standard form table 221 to read out the information on output form of medical image output apparatus 50a or 50b defined as an output destination (output form information). After that, the process follows the same as in the first embodiment.

Standard form table 222 is a table defining output form information of medical image output apparatus 50a or 50b defined as a standard form as standard form information. The standard form is an output form of the selected medical image output apparatus when unifying the output form of the medical image output apparatuses 50a and 50b having different output forms into an output form of either one of the medical image output apparatuses. In standard form table 222, stored is output form information of the medical image apparatus associated with apparatus ID of the selected medical image output apparatus as the standard form information, as shown in FIG. 4.

Referring to FIG. 9, the following describes the output control processing to be implemented by controller 20 having received the instruction information for film output.

After Steps S1′ and S2′ the same as in the first embodiment, in the case where a decision has been made that the medical image output apparatus defined as the destination of output is the upper portion type one, according to the present embodiment, the process of reversing is set to the “cancel” state to ensure that the output of film sheet is carried out as usual without any special process because the output form of upper portion type medical image output apparatus 50b has been set as the standard form (Step S3′).

After the employ/cancel state of reversing has been set, output order of film sheets to be outputted is set. Regarding setting of the output order, since the output form of upper portion type medical image output apparatus 50b has been set as the standard form as described above and film output can be conducted as usual without a special process, the rearrangement process of the output order is not carried out. That is, the parameter “n” showing the order of outputting the medical image is set for each medical image, to ensure that the order will be the same as the order specified as that of image diagnosis of the medical image (Step S4). After that, the process goes to Step S7.

The following describes the case where the destination of output is the side face type apparatus.

Based on the standard form information read out at Step S1′ and output form information having been read out, the employ/cancel state of reversing is set so as to ensure that the output form of film sheet will be according to the output form of medical image output apparatus 50b being the standard form when the film outputting is carried out by side face type medical image output apparatus 50a. The standard form is the output form of upper portion type medical image output apparatus 50b, and therefore, the process of reversing is set to the “employ” state to ensure that the medical image and the supplementary information thereof will become a correct image, in response to the characteristics of the output form of the side face type apparatus (Step S5′). This means that reversing is carried out in the case of the side face type apparatus.

After the employ/cancel state of reversing has been set, output order of film sheets to be outputted is set. Regarding setting of the output order, since the output form of upper portion type medical image output apparatus 50b has been set as the standard form as described above and film output can be conducted as usual without a special process, the rearrangement process of the output order is not carried out. That is, the parameter “n” showing the order of outputting the medical image is set for each medical image, to ensure that the order will be the same as the order specified as that of image diagnosis of the medical image (Step S4). After that, the process goes to Step S7.

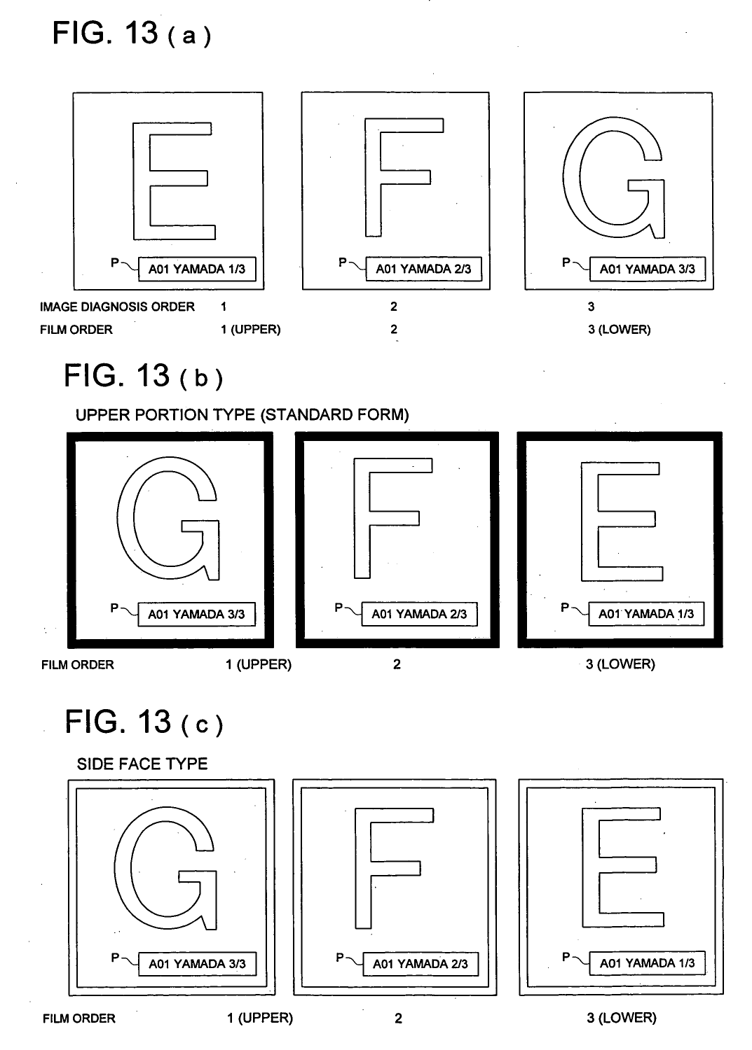

The output form of film sheets ejected on tray 61 and stored by the above film output processing conducted by each medical image output apparatus 50a or 50b will be explained with reference to FIG. 13, when three images “E”, “F” and “G” are outputted on the film, by way of an example. In FIG. 13, the film enclosed in a black frame in FIG. 13 is shown as viewed from the surface of the image formed surface and the film enclosed in a white frame in FIG. 13 is shown as viewed from the surface opposite to the image formed surface, namely, the surface of the substrate. A correct image is indicated when the text of “E”, “F” or “G” or supplementary information “p” is given by solid lines, and a mirror image is indicated when the text is given by dotted lines.

When “E”, “F” and “G” are specified to be outputted in that order as shown in FIG. 13(a), all the medical images “E”, “F” and “G” of the films stored on the tray of upper portion type medical image output apparatus 50b are correct images, and films arranged in the opposite order as that of image diagnosis must be outputted, as shown in FIG. 13 (b), in such a way that the first top film carries medical image “G”, the second one carries medical image “F” and the third one carries medical image “E”. In this case, supplementary information “p” is located at the lower right, and the text is represented in a correct image.

On the other hand, when a group of film sheets outputted by side face type medical image output apparatus 50a, as shown in FIG. 13(c), the medical images are correct images, and the films are arranged in the opposite order as that of image diagnosis, in such a way that the first top film of the group carries medical image “G”, the second one carries medical image “F” and the third one carries medical image “E”. Supplementary information “p” is located at the lower right, and the text is represented in a correct image. This shows agreement with the targeted output form (output form shown in FIG. 13 (b)).

As described above, in the presence of medical image output apparatuses 50a and 50b having different output forms, the present invention unifies the output forms, when film outputting is performed by either of medical image output apparatus 50a or 50b, because the output form of medical image output apparatus 50a can be conformed to the output form of medical image output apparatus 50b by reversing the medical image to be outputted and/or rearranging the order of output, in response to the characteristics of each of the output forms of medical image output apparatuses 50a and 50b. Thus, the present invention standardizes the film operation procedure for the operator and improves the work efficiency because the operator may only manipulate film sheets outputted from medical image output apparatus 50a in the same manner as the film operation for medical image output apparatus 50b.

According to the explanation above, the output form of upper portion type medical image output apparatus 50b is set as the standard form, however, for example, while the output form of side face type medical image output apparatus 50a is set as the standard form, reversing and/or output order rearrangement of medical images to be outputted from medical image output apparatus 50b can be conducted according to output form of medical image output apparatus 50a so that the output form accords to medical image output apparatus 50a as the standard form. The operator can unify the film manipulation method into that for medical image output apparatus 50a and can facilitate the work.

### The Third Embodiment

First, the overall structure will be explained.

Medical image output apparatus 50b of an embodiment is shown in FIG. 5(b).

Medical image output apparatus 50b which forms a medical image on film sheet based on medical image data and outputs it is one of the upper portion type so that tray 61 is mounted on the upper portion of the apparatus. The basic structure of the apparatus is similar to that of the first and second embodiment.

In the film output process, when a medical image to be outputted and its output instruction information are inputted through communication section 54, a patient whose medical image was taken is recognized, referring to the supplementary information written into the header area of an inputted medical image. In a medical image, various kinds of information is usually annexed as supplementary information, being such as patient information related to the patient whose medical image is taken (for example, patient name or patient ID and the like) and imaging information related to imaging (imaging condition or modality ID of the modality in which the medical image is created or the like). In this embodiment, various kinds of information related to the above medical image is written and annexed in a header area of the medical image. Output instruction information is information related to film output of the medical image, and includes instruction information such as film size and medical image magnification (or reduction ratio), and when medical images of the same patient are outputted in one time, patient ID, image ID of each medical image to be successively outputted and in addition, information of the designated image-diagnosis order of the medical images are included in it.

Next, based on output instruction information, whether output of multiple medical images for a single patient is instructed to be conducted is judged, and in the case of output of multiple images, output order opposite to the input order of each medical images is set, and created is image data for output (the formed image is correct image) in which each medical image and its supplementary information are arranged in the set output order according to the output format corresponding to the correct image, and image forming is carried out based on the image data for output in each apparatus. On the other hand, in the case that film output of a single medical image for one patient is instructed to be conducted, a medical image and its supplementary information are reversed and image data for output (the formed image is a mirror image) positioned according to an output format corresponding to a mirror image is created, and then image forming is carried out based on the image data for output. That is, an output controlling means can be realized in conjunction with controller 51 and a film output processing program.

Communication section 54 is composed of a communicative interface such as an NIC (Network Interface Card) or a modem and conducts data communication with respective apparatuses in the communication network. For example, communication section 54 preserves obtained medical images as a database, communicates with managing image servers through the communication network and receives medical image data to be outputted. Data of medical images obtained by each modality such as a CR, a CT or an MRI are received by communicating with various kinds of modalities. The received data of medical images are outputted to image memory 53.

Next, the operation of above medical image output apparatus 50b will be explained.

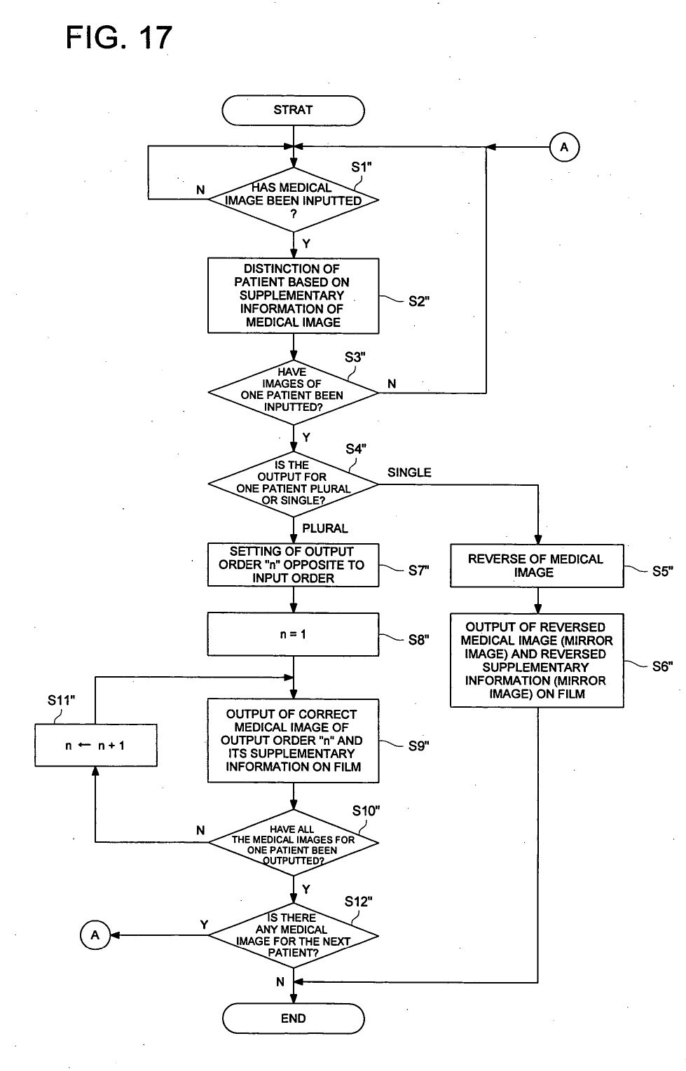

FIG. 17 is a flowchart explaining a film outputting process performed by medical image output apparatus 50b.

In the film output process shown in FIG. 17, first, input of medical image to be outputted is held to wait and whether medical image data and output instruction information have been inputted is judged through communication section 54 (Step S1″). If it is judged that the medical image data and the output instruction information have been inputted (Step S1″; Y), supplementary information of the inputted medical image is read out from the header area of the medical image, and the patient whose medical image was taken is recognized based on the patient ID information included in the read-out supplementary information (Step S2″).

Next, output instruction information which is inputted with a medical image is referred to and all the medical images of one patient have been inputted or not is judged (Step S3″). When successive output of multiple medical images has been required (hereinafter outputting multiple medical images successively is referred to as multiple output), and if all the medical images have not been inputted yet (Step S3″; N), the process returns to Step S1″, where input of the next medical image is held to wait.

On the other hand, when one medical image for one patient, namely, output of a single film is commanded to be conducted (hereinafter outputting a single medical image is referred to as single output), and the medical image of the patient has been inputted, or when multiple output is instructed to be conducted, regarding one patient and when all the instructed medical images have been inputted (Step S3″; Y), which output, multiple output or single output, is indicated for the medical images of a single patient is judged (Step S4″).

First, the case of single image output instruction will be explained.

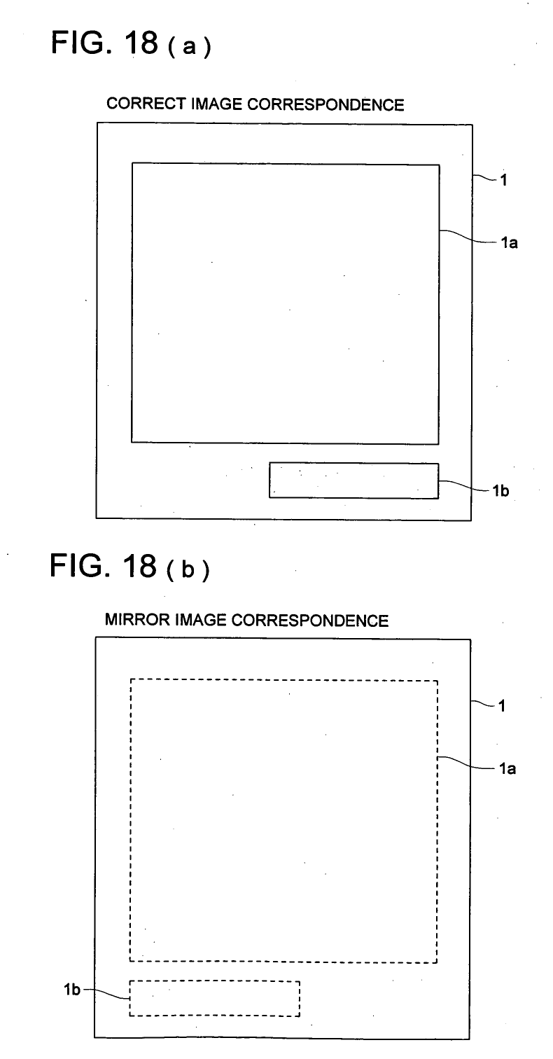

When single image output is instructed (Step S4″; single), a mirror image is created by reversing one inputted medical image (Step S5″). Next, image forming on a film sheet is conducted by exposure and development according to the prescribed output format. The output format has two types, one corresponding to the correct image shown in FIG. 18(a) and the other corresponding to the mirror image shown in FIG. 18(b). As shown in FIGS. 18(a) and 18(b), in each format, image area “1a” inside of which an image is formed and supplementary information area “1b” in which a text of the supplementary information related to the medical image and the positions of image area “1a” and supplementary information area “1b” of each format have a mirror image relationship to each other. That is, since image area “1a” is located in the center of film sheet 1, there is no position change between the correct image and the mirror image, however regarding supplementary information area “1b”, it is located at the lower right on film sheet 1 according to the output format corresponding to a correct image and it is located at the lower left on the film sheet 1 according to the output format corresponding to a mirror image, and has a mirror image relationship. In the case of a single output, the output format corresponding to the mirror image of FIG. 18(b) is employed during image forming, and based on created image data of the mirror image of the medical image, figures indicating patient ID, patient name, an image diagnosis order/total number of outputted images, are formed on the position corresponding to supplementary information area “1b” (at the lower right on film sheet) while a mirror image of the medical image is formed on the position corresponding to image area “1a” on film sheet 1 (Step S6″). When film sheet 1 on which the image has been formed is ejected onto tray 61, this process ends.

Next, to be explained will be the case in which multiple medical images of one patient.

When output of multiple medical images of one patient is instructed to be conducted (Step S4″; multiple), output order “n” is set opposite to the input order regarding multiple medical images of one patient (Step S7″). Next, output order “n” is initially set to value “n−1” (Step S8″) and medical image data of set output order “n” is read out from image memory 53. Then, image forming on a film sheet is carried out with exposure and development, according to the output format corresponding to the correct image (refer to FIG. 18 (a)). First, based on the read-out medical image data, a correct image of the medical image is formed at a position of film sheet 1 corresponding to image area “1a” specified by the output format and figures indicating the patient's ID, name, image diagnosis order/the total number of outputted images are formed at a position (at the lower right on film sheet 1) corresponding to supplementary information area “1b” specified by the output format (Step S9″).

When film sheet 1, on which an image has been formed is ejected onto tray 61, judged is whether all the film sheets of one patient have been outputted (Step S10″), and in the case that all the film sheets have not yet been outputted, (Step S10″; N), the parameter of output order “n” is incremented by “1” (Step S11″), and the process returns to Step S9″. That is, the parameter of output order “n” is incremented one by one and film sheets of the image data for output of the incremented output order “n” is outputted until all the film sheets have been outputted.

After all the film sheets of image data for output have been outputted (Step S10″; Y), judged is whether medical image data of the next patient have been inputted (Step S12″) and when they have been inputted (Step S12″; Y), the process returns to Step S1″, so that the process of Steps S1″ to S10″ is repeated. On the other hand, when no medical image data of the next patient are inputted (Step S12″; N), the process ends.

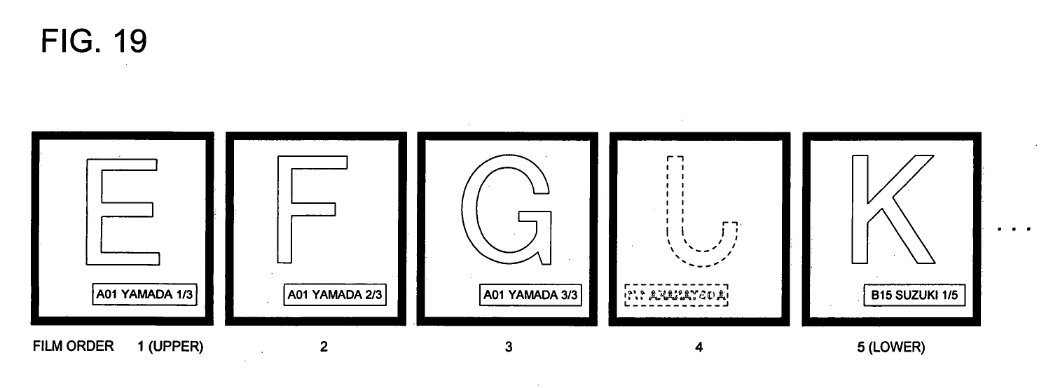

An example of the film sheets outputted by the above film output process is shown in FIG. 19.

FIG. 19 is a view showing the state of arrangement of the film sheets according to the film sheet order, of an accumulated film sheet group ejected onto the output tray, in the case that film output of patients “Yamada”, “Tanaka” and “Suzuki” in that order is commanded to be conducted, specifically, multiple output of three medical images E, F and G regarding patient “Yamada”, single output of one medical image J regarding patient “Tanaka” and multiple output of five medical images K, regarding “Suzuki” are commanded to be carried out. In FIG. 19, films enclosed in black outer frames are viewed from the image forming surface side of the film. Further, if letters E-G, J and K and texts of the supplementary information are illustrated with solid lines, the images are correct images and if they are illustrated with dotted lines, the images are mirror images.

As further shown in FIG. 19, film sheets are ejected so that image formed surfaces face up in either case of multiple output or single output, however it is to be noted that each of the film sheets of a multiple output is outputted as a correct image while each film sheet of a single output is outputted as a mirror image. Regarding the supplementary information of medical images, since the film output is carried out as the same form, the text is a correct image in the multiple output and the position of it is at the lower right of the film sheet while in the single output it is a mirror image and located at the lower left of the film sheet. Further, the output order of film sheets outputted as a multiple output follows the image diagnosis order.

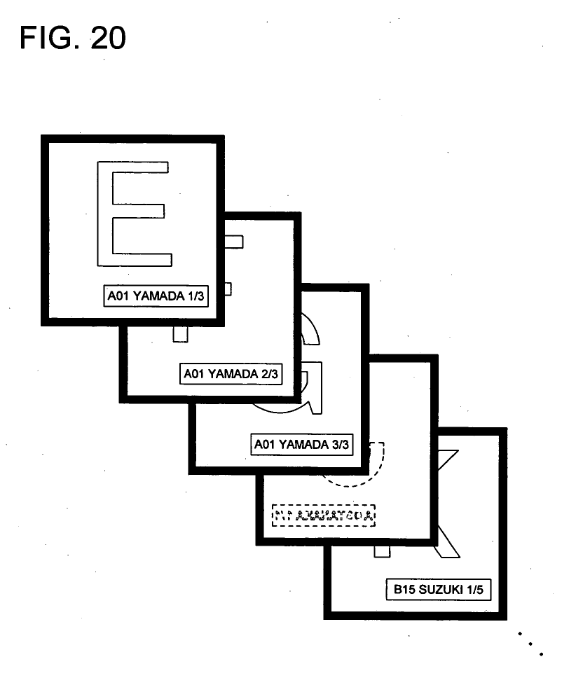

As stated above, according to these embodiments, since film sheets are outputted so that an image formed on a film sheet of the multiple output is a correct image when viewed from above while an image on a film sheet of the single output is a mirror image to make the multiple output and single output have different output forms, and an operator takes out the film sheets and can easily distinguish by observing the position of the supplementary information, in the case of the group of film sheets shown in FIG. 19, for example, they are accumulated as in FIG. 20 when they are taken out. Therefore, the operator can easily check the position of the supplementary information while flipping the lower portion of the film sheets and search for film sheets having the supplementary information at the lower right to find the desired film sheets in the case of multiple output and a film sheet having it at the lower left to find the desired film sheet in the case of single output. In this case, the searching work becomes much easier because of pattern recognition (whether the text is located left or right) instead of letter recognition (whether the text is reversed or not).

Therefore, even when a small number of CR image film sheets are mingled with a large number of CT or MRI film sheets, it is still quite easy to segregate the desired film sheets from among film group and the sorting work can be greatly facilitated.

Since a medical image output apparatus based on the DICOM (Digital Imaging and Communication in Medicine) standard generally incorporates a function to overlay supplementary information such as a patient ID, if the present invention is employed, even when medical image output apparatus of several manufactures are integrated in one system, films of each patient are distinguished easily without a special process, such as marking which is carried out every time when the patients of the images changes, so that a mark is formed on the film sheet of the new patient to indicate the patient's change.

In the case of multiple output, the output order is changed to comply with the film sheet order, therefore, when the film sheets are arranged on a light box, it is sufficient to only take each film sheet from the top of bundle of film sheets to place them on the light box without special manipulation such as turning the film sheets or changing their order. Accordingly the work can be much facilitated.

In the above embodiment, the apparatus is controlled to procure a correct image in the case of multiple output and a mirror image in the case of single output. It is, of course, also possible to obtain the opposite state (a mirror image in the multiple output and a correct image in the single output). The output form is not especially restricted, only if the form is different.

In the above embodiment, explained was the example of medical image output apparatus 50b, being of the upper portion type, in which tray 61 is mounted on the upper portion of the apparatus and film sheets are outputted with the image formed surface facing upward. However the apparatus is not limited to only this type if different output forms can be obtained between multiple output and single output.

For example, as shown in FIG. 5(a), the present invention is even applicable to medical image output apparatus 50a in which the tray is mounted on the side face of the apparatus and film sheets are outputted with the image formed surface facing downward. In the case of medical image output apparatus 50a, when the outputted film sheet ejected on tray 61 is viewed from above (direction “A”), the medical image formed on film sheet 1 is a mirror image because the substrate is oriented toward the operator. Accordingly, in the case of single output, a correct images of a medical image and its supplementary information are formed on film sheet 1 as usual and outputted, and in the case of multiple output, the output order of each medical image is set to be opposite to the input order while mirror images of a reversed medical image and its supplementary information are formed on film sheet 1. By this means, when the film is viewed from direction “A”, each film sheet 1 of the multiple output of one patient has a correct image and film sheet 1 of the single output of one patient has mirror image, which is a different output form. Accordingly, even when film sheets 1 carrying images for plural patients are accumulated on tray 61, an operator can easily-segregate the desired films from among the film group.

As shown in FIGS. 14(a) and 14(b), the present invention is also applicable to a case in which plural trays 61-63 are mounted and a sorter is installed into the apparatus. In this case, for example, while switching among trays 61-63 whenever there is a patient change, and on segregating film sheets of one patient, film sorting work of operators is greatly reduced by changing output forms between multiple output of CT medical images and single output of CR medical images.

Further, in the embodiment, the output is controlled by medical image output apparatus 50b, however it is not limited to the apparatus, for example as shown in FIG. 1, in medical image output system 100 including medical image output apparatus 50b of the upper portion type and medical image output apparatus 50a of side face type, controlling apparatus 20 controls the output. In this case, stored in controlling apparatus 20 is output form information showing characteristics of output form (which direction, upward or downward, image surface orientation after ejection or which image, correct image or mirror image, is observed on an ejected film sheet on the tray viewed from above) of each medical image output apparatus 50a and 50b. Further, whether the reversing process applies to the medical image and its supplementary information or not and output order of the medical images are set based on the output form information of each medical image output apparatus 50a or 50b when the medical images to be outputted are provided to either medical image output apparatus 50a or 50b, in order to make a single sheet output and multiple sheet output have different output forms. Then, the setting information is sent to either medical image output apparatus 50a or 50b as output instruction information along with medical images to be outputted as film sheets.

In the above embodiment, output control is carried out so that the multiple output and the single output have different output forms, however, it is not limited to this and the output form can be changed every time there is a patient change, or it can be changed based on the instruction of the film output instead of being based on the patient. For example, since film output instructions are inputted by respective image diagnosing doctors, each of the image diagnosing doctors can quickly recognize a film group to which they made an output instruction if the output form is based on film output instructions even when a large number of film sheets are outputted.

In the case of medical image output system 100 shown in FIG. 1, it is so structured that instruction of film output is conducted in image diagnosis terminal 30 and film output is commanded to medical image output apparatus 50a or 50b according to the instruction in controller 20, and therefore, when instruction for film output is conducted in image diagnosis terminal 30, image diagnosing doctors is certified and information of that doctor is sent to controller 20 with instruction information for film output so that output control can be carried out in controller 20 by switching the output forms for each doctor. By this means, each image diagnosing doctor can quickly recognize a film group to which he/she provided an output instruction because films outputted from medical image output apparatus 50a or 50b have a different output form depending on each image diagnosing doctor.

Further, the output forms can also be changed whenever modalities 10 are changed. When a medical image is created in modality 10, modality ID (information to identify each individual modality) of modality 10 is annexed. Accordingly, the kind of modality is identified from the modality ID annexed to the medical image instructed to be outputted, in controller 20 and output control is carried out so that output forms are changed whenever modalities are changed. Since multiple image output is often employed to output medical images created in a modality such as CT or MRI and single image output is often employed to output medical images created in a modality such as CR, it is easy to separate film groups from ones created in different modalities among a large number of outputted film groups by switching output forms on the basis of the modalities.

What is claimed is:

1. A medical image output system; comprising:
a plurality of medical image output apparatuses to form a medical image of a patient on a film sheet and to output the film sheet on which the medical image is formed, in different output forms; and
a controlling section to control the plurality of medical image output apparatuses;
wherein the controlling section comprises:
an output form storage section to store the output form information of the plurality of medical image output apparatuses;
a standard form storage section to store a standard form information defining a standard output form; and
an output control section to output the film sheet from each medical image output apparatus by executing at least one of a reversing process to reverse the medical image to be outputted, to obtain a correct image or a mirror image, and a rearranging process to rearrange the output order of the medical images, so that the film sheet is outputted in the standard output form, from each medical image output apparatus, based on the stored output form information and the stored standard form information of each medical image output apparatus.

2. The medical image output system of claim 1,
wherein the standard output form is such that, when film sheets outputted from each medical image output apparatus are viewed from the top of the film sheets, medical images formed on the film sheets are correct images, and the film sheets on which the medical images are formed are piled in an image diagnosis order of the medical images.

3. The medical image output system of claim 1,
wherein the standard output form is selected among the output forms of the plurality of medical image output apparatuses.

4. The medical image output system of claim 1,
wherein the output control section outputs supplementary information with the medical image, on the film sheet.

5. The medical image output system of claim 1,
wherein a glossiness of the film sheet is almost same on both sides.

6. The medical image output system of claim 4,
wherein the film sheet the glossiness of which is almost same is a film sheet for heat development, containing a photosensitive layer on a substantially transparent substrate.

7. A medical image output method in a medical image output system including a plurality of medical image output apparatuses for outputting a film sheet on which a medical image is formed, in different forms; comprising the steps of:
storing an output form information of the plurality of medical image output apparatuses in an output form storage section;
storing a standard form information defining a standard output form in a standard form storage section; and
outputting the film sheet from each medical image output apparatus by executing at least one of a reversing process to reverse the medical image to be outputted, to obtain a correct image or a mirror image and a rearranging process to rearrange the output order of the medical images, so that the film sheet is outputted in the standard output form, from each medical image output apparatus, based on the stored output form information and the stored standard form information of each medical image output apparatus.

8. The medical image output method of claim 7,
wherein the standard output form is selected among the output forms of the plurality of medical image output apparatuses.

9. A medical image output apparatus outputting a medical image of a patient onto a film sheet; comprising:
an output device to output the medical image and supplementary information of the medical image onto the film sheet and to eject the film sheet and
an output control device to execute a reverse process of the medical image and the supplementary information to obtain a correct image or a mirror image, to produce different output forms between cases in which plural medical images are outputted and a single medical image is outputted, and to output the reversed medical image and the reversed supplementary information by the output device.

10. The medical image output apparatus of claim 9,
wherein, when plural medical images are outputted for one patient, the output control device executes a rearranging process to rearrange an output order of medical images so as to make an order of the medical images formed on outputted film sheets accord to an image diagnosis order, while the medical images formed on the film sheets are viewed as correct images, and outputs the film sheets in the rearranged output order by the output device.

11. The medical image output apparatus of claim 9,
wherein a glossiness of the film sheet is almost same on both sides.

12. The medical image output apparatus of claim 11,
wherein the film sheet the glossiness of which is almost same is a film sheet for heat development, containing a photosensitive layer on a substantially transparent substrate.

13. A medical image output method for outputting a medical image of a patient and supplementary information of the medical image onto a film sheet; comprising steps of:
executing a reverse process of the medical image and the supplementary information to obtain a correct image or a mirror image, to produce different output forms between cases in which plural medical images are outputted and a single medical image is outputted and
outputting the reversed medical image and the reversed supplementary information onto a film sheet by a output device.
